(19) United States
(12) Patent Application Publication
(10) Pub. No.: US 2026/0275459 A1
(43) Pub. Date: Sep. 17, 2026

(54) NICKEL-BASE ALLOY

(71) Applicant: ATI Properties LLC, Albany, OR (US)

(72) Inventors: Reza Sharghi-Moshtaghin, Charlotte, NC (US); John W. Foltz, IV, Matthews, NC (US); Christopher M. O’Brien, Black Mountain, NC (US); Joseph A. Jankowski, Matthews, NC (US); Andrew Temple, Indian Trail, NC (US); Matias Garcia-Avila, Matthews, NC (US)

(21) Appl. No.: 19/669,645

(22) Filed: May 6, 2026

Related U.S. Application Data
(63) Continuation of application No. 18/343,272, filed on Jun. 28, 2023, now abandoned.
(60) Provisional application No. 63/367,170, filed on Jun. 28, 2022.

(51) Int. Cl. C22C 19/05; B22F 9/08; B22F 10/28; B33Y 10/00; B33Y 70/00; B33Y 80/00; C22F 1/00; C22F 1/10

(52) U.S. Cl. CPC C22C 19/056; B22F 9/082; B22F 10/28; B33Y 10/00; B33Y 70/00; B33Y 80/00; C22F 1/002; C22F 1/10; B22F 2201/11; B22F 2301/15; B22F 2998/10; B22F 2999/00

(57) ABSTRACT

A gamma-prime strengthened nickel-based alloy includes, in weight percentages based on total weight of the nickel-base alloy: 15% to 18% chromium; 16% to 19% cobalt; 2% to 4% molybdenum; 1.5% to 5% tungsten; 0 to 2% niobium; 1% to 3% aluminum; 2% to 5% titanium; 0 to 2% tantalum; 0 to 4% iron; 0 to 0.5% hafnium; 0 to 0.2% carbon; 0 to 0.02% boron; 0 to 0.1% zirconium; and nickel, where the nickel-based alloy has a Ti_{eq}/Al_{eq} ratio of 0.9 to 1.25, and Ti_{eq} of 2.0 to 7.15, and the nickel-based alloy has 25-40% gamma-prime as measured at 1500° F. Also disclosed is a method of forming a component that includes providing a powder comprising the nickel-base alloy; additively manufacturing the component from the powder; and heat treating the additively manufactured component.

### CROSS-REFERENCE TO RELATED APPLICATIONS

This application is a continuation of and claims priority to U.S. Ser. No. 18/343,272 filed on Jun. 28, 2023, which claims priority to U.S. Provisional Patent Application No. 63/367,170, which was filed on Jun. 28, 2022, the contents of each of which are hereby incorporated by reference in their entirety.

### FIELD

The present invention relates to the field of metallurgy and more particularly relates to nickel-base alloys. Embodiments of nickel-base alloys according to the present disclosure are suitable for use in structural applications subjected to high temperatures, e.g., greater than 1200° F. (649° C.).

### BACKGROUND

Various commercially available nickel-base alloys are suitable for static structural applications subjected to temperatures up to about 1200° F. (649° C.). Certain of these available alloys are used in static components of turbine engines including, for example, compressor discharge nozzle (CDN) case, combustor case, and high/low pressure turbine (HPT/LPT) case components. As an example, Waspaloy alloy (UNS N07001) is used in CDN and low pressure turbine cases of the GE9X aircraft turbofan engine of the Boeing 777X aircraft. Waspaloy alloy has the following broad weight percentage composition: 18.00-21.00 chromium, 3.50-5.00 molybdenum, 12.00-15.00 cobalt, 1.20-1.60 aluminum, 2.75-3.25 titanium, 0.003-0.01 boron, 0.02-0.10 carbon, 0.02-0.08 zirconium, max. 2.00 iron, max. 0.10 manganese, max. 0.15 silicon, max. 0.015 phosphorus, max. 0.015 sulfur, max. 0.10 copper, balance nickel. The static turbine case components are seamless parts and may be formed by a sequence of steps including forging, punching, and ring rolling at high temperatures, approx. 2000° F. (1093° C.).

In next generation turbine engine designs, an objective is to increase component temperatures to increase engine efficiency. In certain designs under consideration, temperatures may approach 1500° F. (816° C.). At these higher operating temperatures the mechanical properties of current commercial nickel-base alloys may not meet design requirements. Approaches that have been considered to increase high temperature properties of nickel-base alloys include increasing gamma-prime phase and/or alloying element content. Those approaches, however, can make the resulting alloy more susceptible to microstructural instability.

Accordingly, there is a need for novel nickel-base alloys having properties suitable for use in high temperature environments, such as temperatures approaching 1500° F. (816° C.). In particular, there is a need for novel nickel-base alloys having properties suitable for use in structural parts of turbine engines and which are subjected to temperatures approaching 1500° F. (816° C.).

### SUMMARY

An embodiment of a nickel-base alloy according to the present disclosure comprises, in weight percentages based on total alloy weight: 11 to 18 chromium; 16 to 28 cobalt; 1.5 to 7.0 molybdenum; 0 to 6.5 tungsten; 0 to 1.0 niobium; 1.0 to 2.5 aluminum; 2.0 to 6.0 titanium; 0 to 2.0 tantalum; 0 to 4.0 iron; 0 to 0.5 hafnium; 0.01 to 0.2 carbon; 0.001 to 0.02 boron; 0.001 to 0.1 zirconium; nickel; and impurities. Certain non-limiting embodiments of the nickel-base alloy of this embodiment comprise 16 to 19 weight percent cobalt. In certain non-limiting embodiments of the nickel-base alloy of this embodiment, an aluminum equivalent number (Al_{eq}) of the alloy is in a range of 3.6 to 4.5. Certain of the nickel-base alloys of this embodiment comprise a combined concentration of aluminum and titanium no greater than 7.0 weight percent, based on total alloy weight.

An additional embodiment of a nickel-base alloy according to the present disclosure comprises, in weight percentages based on total alloy weight: 11 to 16 chromium; 16 to 28 cobalt; 1.5 to 7.0 molybdenum; 0 to 6.5 tungsten; 0 to 1.0 niobium; 1.0 to 2.5 aluminum; 2.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; at least 36 nickel; and impurities. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5. In certain non-limiting embodiments of the nickel-base alloys of this embodiment, a combined concentration of aluminum, niobium, and titanium is no greater than 7.0 weight percent.

An additional embodiment of a nickel-base alloy according to the present disclosure comprises, in weight percentages based on total alloy weight: 11 to 18 chromium; 24 to 28 cobalt; 1.5 to 7.0 molybdenum; 2.0 to 6.0 tungsten; 0 to 1.0 niobium; 1.0 to 2.5 aluminum; 2.0 to 6.0 titanium; 0 to 2.0 tantalum; 0 to 4.0 iron; 0 to 0.5 hafnium; 0.01 to 0.2 carbon; 0.001 to 0.02 boron; 0.001 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment comprise a combined concentration of aluminum and titanium no greater than 7.0 weight percent, based on total alloy weight.

An additional embodiment of a nickel-base alloy according to the present disclosure comprises, in weight percentages based on total alloy weight: 14 to 16 chromium; 24 to 27 cobalt; 1.5 to 7.0 molybdenum; 0 to 6.5 tungsten; 0 to 1.0 niobium; 1.7 to 2.0 aluminum; 3.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium no greater than 7.0 weight percent, based on total alloy weight.

An additional embodiment of a nickel-base alloy according to the present disclosure comprises, in weight percentages based on total alloy weight: 13 to 17 chromium; 16 to 25 cobalt; 1.5 to 7.0 molybdenum; 0 to 6.5 tungsten; 0 to 1.0 niobium; 1.0 to 2.5 aluminum; 3.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; optionally, trace elements; at least 36 nickel; and impurities. In certain non-limiting embodiments, the nickel-base alloys of this embodiment include an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

An additional embodiment of the nickel-base alloy according to the present disclosure comprises, in weight percentages based on total alloy weight: 13 to 17 chromium; 16 to 19 cobalt; 1.5 to 7.0 molybdenum; 2.0 to 5.0 tungsten; 0 to 1.0 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

An additional embodiment of the nickel-base alloy according to the present disclosure comprises, in weight percentages based on total alloy weight: 14 to 17 chromium; 19 to 25 cobalt; 2.0 to 4.0 molybdenum; 0 to 6.5 tungsten; 0 to 0.8 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

An additional embodiment of the nickel-base alloy according to the present disclosure comprises, in weight percentages based on total alloy weight: 14 to 17 chromium; 16 to 19 cobalt; 2.0 to 4.0 molybdenum; 2.0 to 5.0 tungsten; 0 to 1.0 niobium; 1.0 to 2.5 aluminum; 3.0 to 6.0 titanium; greater than 0 to 2.0 tantalum; 1.0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

An additional embodiment of the nickel-base alloy according to the present disclosure comprises, in weight percentages based on total alloy weight: 15 to 17 chromium; 22 to 26 cobalt; 2.0 to 4.0 molybdenum; 0 to 2.0 tungsten; 0 to 1.0 niobium; 1.0 to 4.0 aluminum; 1.0 to 6.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

An additional embodiment of the nickel-base alloy according to the present disclosure comprises, in weight percentages based on total alloy weight: 14 to 17 chromium; 15 to 18 cobalt; 2.0 to 4.0 molybdenum; 1.0 to 4.0 tungsten; 0 to 1.0 niobium; 1.0 to 3.0 aluminum; 2.0 to 4.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

The present disclosure also is directed to methods of making an alloy having a composition according to the present disclosure and to mill products, powders, and other articles of manufacture consisting of or comprising an alloy according to the present disclosure.

Further areas of applicability of the present invention will be apparent from the detailed description provided hereinafter. It should be understood that the detailed description and any specific examples herein, while indicating certain embodiments of the invention, are intended for purposes of illustration only and are not intended to limit the scope of the invention.

### BRIEF DESCRIPTION OF THE DRAWINGS

The present invention will be more fully understood from the following detailed description and the accompanying drawings, which are not necessarily to scale, wherein:

FIG. 1 is a photograph showing the twin VIM mold setup used to cast 25 lb. heats in Example 1 herein;

FIG. 2 shows dimensions of the VIM mold setup used to cast 25 lb. heats in Example 1 herein;

FIG. 3 is a photograph showing a cast 25 lb. heat made in Example 1 herein;

FIG. 4 is a plot of yield strength (ksi) as a function of test temperature for certain alloy heats and for certain commercial nickel-base alloys;

FIG. 5 is a plot of ultimate tensile strength (ksi) as a function of test temperature for certain alloy heats and for certain commercial nickel-base alloys;

FIG. 6 is a plot of elongation versus test temperature for several alloy heats;

FIGS. 7-9 are plots of stress rupture results at various identified test conditions;

FIG. 10 is an electron microscope image of the alloy of Example P2F02; and

FIG. 11 is an electron microscope image of the alloy of Example P2F07.

### DETAILED DESCRIPTION OF CERTAIN NON-LIMITING EMBODIMENTS

The reader will appreciate the foregoing details, as well as others, upon considering the following detailed description of various non-limiting and non-exhaustive embodiments according to the present disclosure.

Various non-limiting embodiments are described and illustrated in this specification to provide an overall understanding of the disclosed inventions. It is understood that the various non-limiting embodiments described and illustrated in this specification are non-limiting and non-exhaustive. Thus, the invention is not limited by the description of the various non-limiting and non-exhaustive embodiments disclosed in this specification. The features and characteristics illustrated and/or described in connection with various non-limiting embodiments may be combined with the features and characteristics of other non-limiting embodiments. Such modifications and variations are intended to be included within the scope of this specification. As such, the claims may be amended or supplemented to recite any features or characteristics expressly or inherently described in, or otherwise expressly or inherently supported by, this specification. Further, applicant reserves the right to amend the claims to affirmatively disclaim features or characteristics that may be present in the prior art. The various non-limiting embodiments disclosed and described in this specification can comprise, consist of, or consist essentially of the features and characteristics as variously described herein.

All percentages provided herein for an alloy composition are based on the total weight of the particular alloy composition, unless otherwise indicated herein.

Any patent, publication, or other disclosure material that is said to be incorporated, in whole or in part, by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein is only incorporated to the extent that no conflict arises between that incorporated material and the existing disclosure material.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1 to 10” is intended to include all sub-ranges between (and including) the recited minimum value of 1 and the recited maximum value of 10, that is, having a minimum value equal to or greater than 1 and a maximum value equal to or less than 10, such as, for example, 2.4 to 7.6. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such sub-ranges are intended to be inherently described in this specification such that amending to expressly recite any such sub-ranges would comply with the requirements of 35 U.S.C. §§ 112 and 132(a). Additionally, as used herein when referring to compositional elemental ranges, the term “up to” includes zero unless the particular element is an unavoidable impurity.

The grammatical articles “one”, “a”, “an”, and “the”, as used in this specification, are intended to include “at least one” or “one or more”, unless otherwise indicated. Thus, the grammatical articles are used in this specification to refer to one or more than one (i.e., to “at least one”) of the grammatical objects of the article. By way of example only, “a component” means one or more components and, thus, possibly, more than one component is contemplated and may be employed or used in an implementation of the described embodiments. Further, the use of a singular noun includes the plural, and the use of a plural noun includes the singular, unless the context of the usage requires otherwise.

Reference herein to a nickel-base alloy “comprising” a particular composition is intended to encompass alloys “consisting essentially of” or “consisting of” the stated composition. It will be understood that nickel-base alloy compositions described herein that “consist of” or “consist essentially of” a particular composition also may include impurities.

Nickel-base alloys suitable for use in static structural parts in turbine engines subjected to operating temperatures approaching 1500° F. (816° C.) must maintain suitable mechanical properties at those operating temperatures. A suitable nickel-base alloy must exhibit sufficient ductility to allow a fatigue crack growth rate that will provide damage tolerance and containment. Tensile properties also must be sufficient, but cannot be at the expense of providing sufficient low cycle fatigue (LCF) properties. The alloy also should exhibit suitable high temperature creep properties, fracture toughness, and fatigue crack growth (FCGR) properties. In addition, if the alloy is to be used in turbine case applications, for example, it should be formable by ring rolling. Importantly, the alloy also should be inspectable by non-destructive testing methods, weldable to allow for repair and reconditioning, and, preferably, should meet cost requirements for the application. We address certain of these requirements in greater detail below.

Alloys according to the present disclosure should exhibit suitable tensile properties. In various embodiments, alloys according to the present disclosure exhibit various tensile properties that are at least as high as those of Waspaloy alloy (UNS N07001). A higher gamma-prime volume fraction can enhance tensile properties. The gamma-prime volume fraction can be adjusted, for example, by adjusting the total content of the alloying elements titanium, aluminum, niobium, and tantalum. In general, increasing the total content of those elements in the alloy will increase the gamma-prime volume fraction. An alloy's gamma-prime content can be determined by inspecting alloy microstructure. Gamma-prime fraction also can be approximated by the Al_{eq} number which for purposes of the present disclosure is calculated by the equation:

$${Al}_{eq} = [ Al ] + 0.56 \times [ Ti ] + 0.3 \times [ Nb ] + 0.15 \times [ Ta ]$$

wherein [Al], [Ti], [Nb], and [Ta] are the weight percentage concentrations of the elements in the alloy. A higher gamma-prime volume fraction, however, can degrade forgeability and also can reduce fatigue crack growth resistance properties. The chemistry of the gamma-prime fraction in the alloy can be adjusted by altering the titanium/aluminum ratio, and adjustments to that ratio may alter coherency strain and dislocation particle interaction in the alloy. Antiphase boundary (APB) energy can control cutting of precipitates by dislocations and can be controlled by gamma-prime chemistry, and introducing elements such as niobium into the alloy can change APB energy. Smaller grain size can improve tensile properties. Thermomechanical parameters, sub-solvus versus supersolvus heat treatment, and carbide/gamma-prime content can control grain growth at high temperatures. Matrix chemistry can be modified by solid solution strengthening and by addition of matrix strengthener elements such as molybdenum and tungsten which partition to the gamma phase matrix

Alloys according to the present disclosure should exhibit suitable creep properties. Larger grain size can improve creep properties, but may do so at the expense of tensile properties. Higher gamma-prime volume fraction also can improve creep properties. An increased content of refractory elements such as tungsten and molybdenum also can improve creep properties due to their low diffusion rate.

In various non-limiting embodiments, alloys according to the present disclosure exhibit low cycle fatigue properties that are at least as favorable as those of Waspaloy alloy. Smaller grain size can provide better low cycle fatigue properties. For acceptable low cycle fatigue performance when grain size is, for example, about ASTM 10 to 12, carbonitrides can act as crack initiation sites. Nickel-base alloys used in turbine engine case applications typically are required to have grain size of ASTM 4 to 5, and it is not generally known whether carbonitrides can be detrimental to low cycle fatigue. Balance of gamma-prime volume fraction also can be important in providing suitable low cycle fatigue properties. In certain non-limiting embodiments, the nickel-base alloys according to the present disclosure can comprise a grain size in a range of ASTM 2 to 12, such as, for example, ASTM 2 to 3, ASTM 5 to 12, ASTM 4 to 8, ASTM 4 to 5, ASTM 5 to 6, ASTM 5 to 10, or ASTM 6 to 12.

In various embodiments, alloys according to the present disclosure exhibit acceptable fracture toughness and fatigue crack growth rate characteristics. Larger grain size can improve (reduce) fatigue crack growth rate. To improve fatigue crack growth resistance of nickel-base alloys subjected to high temperature conditions in service, the alloys may be heat treated above their gamma-prime solvus temperature (generally referred to as super-solvus heat treatment) to produce significant, uniform coarsening of grains. Larger grains also may improve hold time fatigue performance, which has a component of creep in the matrix. Fine gamma-prime size in the matrix during loading may result in cutting of precipitates, producing planar slip which reduces fatigue crack growth rate. Increasing gamma-prime phase content may reduce K1C (plane strain) fracture toughness, and the gamma-prime content may influence fatigue crack growth rate in the same way.

In various embodiments, alloys according to the present disclosure may be forged by ring rolling. Ring rolling is particularly important in turbine engine case applications in which the annular parts preferably are seamless. The larger the forging window for an alloy, the better the forgeability. The forging window, in turn, can be adjusted by modifying the gamma-prime solvus temperature (a function of gamma-prime chemistry) and the solidus temperature (a function of matrix chemistry). Carbonitrides content, which is a result of the content of carbon and carbide forming elements (e.g., niobium, titanium) and the balance of gamma-prime content also can influence ring rolling forgeability of the alloy.

In various embodiments, alloys according to the present disclosure exhibit acceptable long-term microstructural stability. To inhibit formation of topologically close packed (TCP) phases, chromium content should be limited and balancing of heavy elements (e.g., tungsten, molybdenum, and niobium) may be necessary. Excessive chromium can destabilize the microstructure and form sigma phase. The alloys according to the present disclosure also preferably exhibit acceptable mechanical property degradation over time. A principal reason for property degradation in nickel-base superalloys is formation of second phases like sigma phase and coarsening of gamma-prime phase. Improved gamma-prime stability can be achieved by including higher aluminum content in the gamma-prime chemistry. The alloy chemistry preferably also should be controlled to have lower lattice mismatch and stable carbides.

Alloys according to the present disclosure also preferably are inspectable using non-destructive testing (NDT) techniques. In general, smaller grain size improves the NDT inspectability of the alloy. Also, avoiding formation of bands of carbonitrides (“carbonitride banding”) improves NDT inspectability.

Alloys according to the present disclosure preferably also have acceptable weldability, for example, so that component parts formed of the alloy can be repaired and overhauled without unacceptably degrading mechanical and other important characteristics of the alloy. In general, the easier it is to weld a high-temperature alloy, the more difficult it is to establish satisfactory creep strength. This problem has been particularly acute in alloys for gas turbine applications. Weldability can be improved by lowering gamma-prime content which, however, may adversely affect certain other characteristics of the alloy.

With the foregoing observations and objectives in mind, non-limiting embodiments of nickel-base alloys according to the present disclosure suitable for high temperature applications comprise, in weight percentages based on total alloy weight, 11 to 18 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel, and impurities. Certain non-limiting embodiments of the nickel-base alloy of this embodiment comprise 16 to 19 weight percent cobalt. In certain non-limiting embodiments, the nickel-base alloys of this embodiment comprise a combined concentration of aluminum and titanium no greater than 7.0 weight percent, based on total alloy weight. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist essentially of, in weight percentages based on total alloy weight, 11 to 18 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel, and impurities. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist of, in weight percentages based on total alloy weight, 11 to 18 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel, and impurities. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5.

Additional non-limiting embodiments of high-temperature nickel-base alloys according to the present disclosure suitable for high temperature applications comprise, in weight percentages based on total alloy weight, 11 to 16 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 36 nickel, and impurities, and wherein the nickel-base alloys include a combined concentration of aluminum, niobium, and titanium that is 5.0 to 7.0 weight percent. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist essentially of, in weight percentages based on total alloy weight, 11 to 16 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 36 nickel, and impurities, and wherein the nickel-base alloys includes a combined concentration of aluminum, niobium, and titanium that is 5.0 to 7.0 weight percent. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist of, in weight percentages based on total alloy weight, 11 to 16 chromium, 16 to 28 cobalt, 1.5 to 7.0 molybdenum, 0 to 6.5 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 36 nickel, and impurities, and wherein the combined concentration of aluminum, niobium, and titanium is 5.0 to 7.0 weight percent. Certain non-limiting embodiments of the nickel-base alloy of this embodiment comprise 16 to 19 weight percent cobalt. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications comprise, in weight percentages based on total alloy weight, 11 to 18 chromium, 24 to 28 cobalt, 1.5 to 7.0 molybdenum, 2.0 to 6.0 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel and impurities. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist essentially of, in weight percentages based on total alloy weight, 11 to 18 chromium, 24 to 28 cobalt, 1.5 to 7.0 molybdenum, 2.0 to 6.0 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel and impurities. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist of, in weight percentages based on total alloy weight, 11 to 18 chromium, 24 to 28 cobalt, 1.5 to 7.0 molybdenum, 2.0 to 6.0 tungsten, 0 to 1.0 niobium, 1.0 to 2.5 aluminum, 2.0 to 6.0 titanium, 0 to 2.0 tantalum, 0 to 4.0 iron, 0 to 0.5 hafnium, 0.01 to 0.2 carbon, 0.001 to 0.02 boron, 0.001 to 0.1 zirconium, nickel and impurities. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications comprise, in weight percentages based on total alloy weight, 14 to 16 chromium, 24 to 27 cobalt, 1.5 to 7.0 molybdenum, 0 to 6.5 tungsten, 0 to 1.0 niobium, 1.7 to 2.0 aluminum, 3.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 46 nickel, and impurities, and wherein a combined concentration of aluminum, niobium, and titanium is 5.0 to 7.0 weight percent. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist essentially of, in weight percentages based on total alloy weight, 14 to 16 chromium, 24 to 27 cobalt, 1.5 to 7.0 molybdenum, 0 to 6.5 tungsten, 0 to 1.0 niobium, 1.7 to 2.0 aluminum, 3.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 46 nickel, and impurities, and wherein a combined concentration of aluminum, niobium, and titanium is 5.0 to 7.0 weight percent. In certain non-limiting embodiments, the nickel-base alloys of this embodiment have an aluminum equivalent number (Al_{eq}) in the range of 3.6 to 4.5.

Additional non-limiting embodiments of nickel-base alloys according to the present disclosure suitable for high temperature applications consist of, in weight percentages based on total alloy weight, 14 to 16 chromium, 24 to 27 cobalt, 1.5 to 7.0 molybdenum, 0 to 6.5 tungsten, 0 to 1.0 niobium, 1.7 to 2.0 aluminum, 3.0 to 6.0 titanium, 0 to 2.0 tantalum, 0 to 4.0 iron, 0 to 0.5 hafnium, 0.01 to 0.2 carbon, 0.001 to 0.015 boron, 0.001 to 0.1 zirconium, at least 46 nickel, and impurities, and wherein a combined concentration of aluminum, niobium, and titanium is 5.0 to 7.0 weight percent. In certain non-limiting embodiments, the nickel-base alloys of this embodiment have an aluminum equivalent number (Al_{eq}) in the range of 3.6 to 4.5.

Additional non-limiting embodiments of a nickel-base alloy according to the present disclosure suitable for high temperature applications comprise, in weight percentages based on total alloy weight: 13 to 17 chromium; 16 to 25 cobalt; 1.5 to 7.0 molybdenum; 0 to 6.5 tungsten; 0 to 1.0 niobium; 1.0 to 2.5 aluminum; 3.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; optionally, trace elements; at least 36 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of a nickel-base alloy according to the present disclosure suitable for high temperature applications consist essentially of, in weight percentages based on total alloy weight: 13 to 17 chromium; 16 to 25 cobalt; 1.5 to 7.0 molybdenum; 0 to 6.5 tungsten; 0 to 1.0 niobium; 1.0 to 2.5 aluminum; 3.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; optionally, trace elements; at least 36 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of a nickel-base alloy according to the present disclosure suitable for high temperature applications consist of, in weight percentages based on total alloy weight: 13 to 17 chromium; 16 to 25 cobalt; 1.5 to 7.0 molybdenum; 0 to 6.5 tungsten; 0 to 1.0 niobium; 1.0 to 2.5 aluminum; 3.0 to 6.0 titanium; 0 to 2.0 tantalum; 0 to 4.0 iron; 0 to 0.5 hafnium; 0.01 to 0.2 carbon; 0.001 to 0.015 boron; 0.001 to 0.1 zirconium; optionally, trace elements; at least 36 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of nickel-base alloys according to the present disclosure suitable for high temperature applications comprise, in weight percentages based on total alloy weight: 13 to 17 chromium; 16 to 19 cobalt; 1.5 to 7.0 molybdenum; 2.0 to 5.0 tungsten; 0 to 1.0 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of nickel-base alloys according to the present disclosure suitable for high temperature applications consist essentially of, in weight percentages based on total alloy weight: 13 to 17 chromium; 16 to 19 cobalt; 1.5 to 7.0 molybdenum; 2.0 to 5.0 tungsten; 0 to 1.0 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of nickel-base alloys according to the present disclosure suitable for high temperature applications consist of, in weight percentages based on total alloy weight: 13 to 17 chromium; 16 to 19 cobalt; 1.5 to 7.0 molybdenum; 2.0 to 5.0 tungsten; 0 to 1.0 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications comprise, in weight percentages based on total alloy weight: 14 to 17 chromium; 19 to 25 cobalt; 2.0 to 4.0 molybdenum; 0 to 6.5 tungsten; 0 to 0.8 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist essentially of, in weight percentages based on total alloy weight: 14 to 17 chromium; 19 to 25 cobalt; 2.0 to 4.0 molybdenum; 0 to 6.5 tungsten; 0 to 0.8 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist of, in weight percentages based on total alloy weight: 14 to 17 chromium; 19 to 25 cobalt; 2.0 to 4.0 molybdenum; 0 to 6.5 tungsten; 0 to 0.8 niobium; 1.0 to 2.5 aluminum; 3.0 to 6.0 titanium; 0 to 2.0 tantalum; 0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications comprise, in weight percentages based on total alloy weight: 14 to 17 chromium; 16 to 19 cobalt; 2.0 to 4.0 molybdenum; 2.0 to 5.0 tungsten; 0 to 1.0 niobium; 1.0 to 2.5 aluminum; 3.0 to 6.0 titanium; greater than 0 to 2.0 tantalum; 1.0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist essentially of, in weight percentages based on total alloy weight: 14 to 17 chromium; 16 to 19 cobalt; 2.0 to 4.0 molybdenum; 2.0 to 5.0 tungsten; 0 to 1.0 niobium; 1.0 to 2.5 aluminum; 3.0 to 6.0 titanium; greater than 0 to 2.0 tantalum; 1.0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist of, in weight percentages based on total alloy weight: 14 to 17 chromium; 16 to 19 cobalt; 2.0 to 4.0 molybdenum; 2.0 to 5.0 tungsten; 0 to 1.0 niobium; 1.0 to 2.5 aluminum; 3.0 to 6.0 titanium; greater than 0 to 2.0 tantalum; 1.0 to 3.0 iron; 0 to 0.5 hafnium; 0.01 to 0.2 carbon; 0.001 to 0.015 boron; 0.001 to 0.1 zirconium; optionally, trace elements; at least 46 nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications comprise, in weight percentages based on total alloy weight: 15 to 17 chromium; 22 to 26 cobalt; 2.0 to 4.0 molybdenum; 0 to 2.0 tungsten; 0 to 1.0 niobium; 1.0 to 4.0 aluminum; 1.0 to 6.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist essentially of, in weight percentages based on total alloy weight: 15 to 17 chromium; 22 to 26 cobalt; 2.0 to 4.0 molybdenum; 0 to 2.0 tungsten; 0 to 1.0 niobium; 1.0 to 4.0 aluminum; 1.0 to 6.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist of, in weight percentages based on total alloy weight: 15 to 17 chromium; 22 to 26 cobalt; 2.0 to 4.0 molybdenum; 0 to 2.0 tungsten; 0 to 1.0 niobium; 1.0 to 4.0 aluminum; 1.0 to 6.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications comprise, in weight percentages based on total alloy weight: 14 to 17 chromium; 15 to 18 cobalt; 2.0 to 4.0 molybdenum; 1.0 to 4.0 tungsten; 0 to 1.0 niobium; 1.0 to 3.0 aluminum; 2.0 to 4.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist essentially of, in weight percentages based on total alloy weight: 14 to 17 chromium; 15 to 18 cobalt; 2.0 to 4.0 molybdenum; 1.0 to 4.0 tungsten; 0 to 1.0 niobium; 1.0 to 3.0 aluminum; 2.0 to 4.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

Additional non-limiting embodiments of the nickel-base alloys according to the present disclosure suitable for high temperature applications consist of, in weight percentages based on total alloy weight: 14 to 17 chromium; 15 to 18 cobalt; 2.0 to 4.0 molybdenum; 1.0 to 4.0 tungsten; 0 to 1.0 niobium; 1.0 to 3.0 aluminum; 2.0 to 4.0 titanium; 0 to 2.0 tantalum; 0 to 4.0 iron; 0 to 0.5 hafnium; 0 to 0.2 carbon; 0 to 0.02 boron; 0 to 0.1 zirconium; nickel; and impurities. In certain non-limiting embodiments, the nickel-base alloys of this embodiment have an aluminum equivalent number (Al_{eq}) in the range of 3.6 to 4.5. In certain non-limiting embodiments, the nickel-base alloys of this embodiment include a combined concentration of aluminum, niobium, and titanium of 5.0 to 7.0 weight percent, based on total alloy weight.

A suitable minimum level of chromium is included in embodiments of the present alloy to provide acceptable oxidation and corrosion resistance. Excessive levels of chromium in combination with cobalt, however, can result in matrix instability and the possibility of sigma phase formation. In certain embodiments of the alloys according to the present disclosure, the chromium content is in a range of 11 to 18 weight percent and, for example, in certain of such alloys may be within a narrower range of 11 to 16, 11 to 15, 11 to 14, 12 to 16, 12 to 15, 12 to 14, 13 to 18, 13 to 17, 14 to 17, 15 to 17, or 14 to 16 weight percent. In certain other embodiments of alloys herein, the chromium content is 11 to 16 weight percent and, in some embodiments, is 14 to 16 weight percent.

Cobalt reduces gamma-prime solvus. Cobalt also reduces stacking fault energy, and as a result may increase the number of annealing twins. Excessive levels of chromium in combination with cobalt, however, may cause precipitation of deleterious second phases, such as sigma phase, which may result in degradation of mechanical properties. To balance these results, in certain embodiments of the alloys according to the present disclosure, the cobalt content is in a range of 15 to 28 weight percent and, for example, in certain of such alloys may be in a narrower range of 16 to 28, 15 to 18, 16 to 27, 16 to 26, 17 to 27, 17 to 26, 18 to 26, 16 to 25, 19 to 25, 20 to 25, 22 to 26, or 19 to 24 weight percent. In certain other embodiments, the cobalt content is in a range of 16 to 19 weight percent and, for example, in certain of such alloys may be within a narrower range of 16 to 18, 16 to 17, 17 to 18, 17 to 19, or 18 to 19 weight percent. In certain other embodiments of alloys herein, the cobalt content is 24 to 28 weight percent and, in some embodiments is in a narrower range of 24 to 27, 24 to 26, 25 to 28, 25 to 27, 26 to 28, or 26 to 27 weight percent.

Molybdenum partitions mainly to the matrix and can strengthen the matrix by a solid solution mechanism. Excessive molybdenum, however, may result in the development of excessive levels of TCP phases in service. The molybdenum content in certain alloys according to the present disclosure is 1.5 to 7.0 weight percent and, for example, in certain of such alloys may be within a narrower range of 2.0 to 6.0, 2.0 to 5.5, 2.0 to 5.0, 2.0 to 4.0. 3.0 to 5.0, 3.0 to 6.0, 4.0 to 6.0, 4.0 to 5.0, 4.5 to 5.5, 3.0 to 7.0, or 4.0 to 7.0 weight percent. A molybdenum content lower than 2.0 weight percent likely would not result in the desired combination of creep resistance, workability, and weldability.

Tungsten partitions mainly to the gamma matrix phase. Addition of tungsten and/or molybdenum increases the lattice parameter of the matrix and can minimize lattice mismatch (or it may even become negative) which can reduce gamma-prime coarsening rate and can strengthen the matrix by a solid solution mechanism. This increases creep resistance. Excessive tungsten, however, may result in the development of excessive levels of TCP phases in service, increases density, and if added in very large amounts can cause the formation of less favorable primary and secondary carbides. Tungsten may be present in certain alloys according to the present disclosure in a concentration of 0 to 6.5 weight percent, and, for example, in certain of such alloys may be within a narrower range of greater than 0 to 6.5, 0 to 5.0, greater than 0 to 5.0, 0 to 0.5, greater than 0 to 0.5, 0 to 2.0, greater than 0 to 2.0, 1.0 to 6.5, 1.0 to 4.0, 1.5 to 6.5, 1.5 to 5.0, 2.5 to 6.5, 2.5 to 5.0, 3.5 to 5.0, 4.0 to 6.0, or 5.0 to 6.5 weight percent. In various embodiments of the alloys herein, the tungsten content is 2.0 to 6.0 weight percent and, for example, in certain of such alloys may be within a narrower range of 2.0 to 5.0, 2.0 to 4.5, 3.0 to 5.0, 4.0 to 6.0, 2.0 to 4.0, or 5.0 to 6.0 weight percent.

As used herein, an alloy composition described as including an element in a concentration of “0 to”, “0 up to”, or simply “up to” some specified upper weight percentage limit means that in certain embodiments of the alloy the element may be absent or may be present in a non-zero concentration and up to the specified upper weight percentage limit. Applicant reserves the right to amend the claims herein to affirmatively recite a non-zero weight percentage lower limit (e.g., “greater than 0”) for any element that may be absent in certain other embodiments of the alloy according to the present disclosure.

In various non-limiting embodiments of nickel-base alloys according to the present disclosure, the concentrations of molybdenum and tungsten in the alloy satisfy the limitation 3%<[Mo]+0.52×[W]<8%, wherein [Mo] and [W] are, respectively, the weight percentage concentrations of molybdenum and tungsten in the alloy. In certain non-limiting embodiments of nickel-base alloys according to the present disclosure, the concentrations of molybdenum and tungsten in the alloy satisfy the limitation 3%<[Mo]+0.52×[W]<5%, wherein [Mo] and [W] are, respectively, the weight percentage concentrations of molybdenum and tungsten in the alloy.

Niobium preferentially partitions to the gamma-prime phase and raises creep resistance and high temperature strength by raising the activation energy for dislocation motion in the gamma-prime phase. Embodiments of alloys according to the present disclosure may include up to 2.0 weight percent niobium. Niobium is known to strongly segregate during solidification and, therefore, in various non-limiting embodiments of the present alloys niobium is absent or its content is kept to a minimum. Preferably, niobium content is no greater than 1.5, 1.0, 0.8, or 0.1 weight percent. In certain embodiments, niobium contents greater than 0.2, 1.0, or 1.5 weight percent may be used to offset some amount of titanium, aluminum, cobalt, molybdenum, and/or tungsten. In various non-limiting embodiments, niobium may be present in certain alloys according to the present disclosure in a concentration of 0 to 2.0 weight percent, such as, for example, greater than 0 to 2.0 weight percent or 0.2 to 1.0 weight percent.

The ratios between aluminum, titanium, niobium, and tantalum, in addition to the combined content of those elements control the solvus temperature of the gamma-prime phase, which is particularly important to an alloy used in structural applications such as, for example, turbine engine cases. Titanium on an atomic basis is more effective than aluminum at increasing the solvus temperature. However, excessive levels of titanium can result in formation of eta phase instead of gamma-prime phase. Turbine engine cases are presently manufactured by steps including ring rolling, which conventionally limits alloys to gamma-prime solvus temperatures no more than about 1900-2000° F. (1038-1093° C.) in order to maintain enough hot workability to allow for large plastic strains during forming. At aluminum concentrations greater than 3.5 weight percent, the alloy's solvus temperature is too high, or the amount of gamma-prime is too high to support acceptable ring rolling capability and/or weldability for certain structural applications, such as for turbine engine cases. Aluminum may be present in certain alloys according to the present disclosure in a concentration of 1.0 to 4.0 weight percent and, for example, in certain of alloy embodiments may be within a narrower range of 1.0 to 3.0, 1.0 to 2.5, 1.25 to 2.0, 1.25 to 1.9, 1.3 to 1.8, 1.5 to 2.5, 1.0 to 2.0, or 1.5 to 2.0 weight percent. In various embodiments of the alloys herein, the aluminum content is 1.7 to 2.0 weight percent.

Titanium strengthens the gamma-prime phase, increasing the resistance of the gamma-prime phase to shearing, and raises solvus temperature and coherency of the gamma-prime phase. These factors strongly influence the strength and creep resistance of the alloy. Titanium is present in certain alloys according to the present disclosure in a concentration of 1.0 to 6.0 weight percent and, for example, in certain of alloy embodiments may be within a narrower range of 2.0 to 6.0, 2.0 to 5.0, 2.0 to 4.5, 2.0 to 4.0, 2.0 to 3.5, 2.0 to 3.0, 2.5 to 3.5, 3.0 to 5.5, 3.0 to 4.0, 4.5 to 5.5, or 3.0 to 6.0 weight percent. In various embodiments of the alloys herein, the titanium content is 3.0 to 4.5 weight percent.

Tantalum can be used to control solvus temperature and coherency of the gamma-prime phase with the matrix. It is also a strong carbide stabilizer, can be beneficial for oxidation resistance, and can improve creep resistance of the gamma matrix at high temperatures. The alloys according to the present disclosure may include up to 2.0 weight percent tantalum, up to 0.5 weight percent tantalum, or up to 0.2 weight percent tantalum. In various non-limiting embodiments of the alloy according to the present disclosure, tantalum is absent. In various embodiments, the tantalum content is greater than 0 to 2.0, greater than 0 to 1.0, greater than 0 to 0.8, 0.2 to 2.0, 0.6 to 2.0, or 1.0 to 2.0 weight percent.

Increasing iron content increases the variety and amount of revert allowed in the alloy, which helps to reduce the production cost for the alloy. The alloy according to the present disclosure may include up to 4.0 weight percent iron or greater than 0 to 4.0 weight percent iron. In various non-limiting embodiments of the alloy according to the present disclosure, iron is absent. In other alloy embodiments, iron content may be up to 3.0, up to 2.0, or up to 1.0 weight percent. In various embodiments of the alloys herein, the iron content is greater than 0 to 3.0 or 1.0 to 3.0 weight percent.

Hafnium is a strong carbide stabilizer and improves creep resistance at high temperatures in the levels according to the present disclosure. Like zirconium, hafnium can also adversely affect weldability due to its strong segregation during solidification. The alloy according to the present disclosure may include up to 0.5 weight percent hafnium. In various non-limiting embodiments of the alloy according to the present disclosure, hafnium is absent. In other alloy embodiments, hafnium may be present in a concentration greater than 0 up to 0.5 weight percent or greater than 0 up to 0.25 weight percent.

The alloy according to the present disclosure includes up to 0.2 weight percent carbon, greater than 0 to 0.2 weight percent carbon, or 0.01 weight percent to 0.2 weight percent carbon. Higher concentrations of carbon may produce smaller average grain size and a narrow grain size distribution, but can also reduce forgeability and low cycle fatigue properties due to formation of carbonitride stringers. In certain non-limiting embodiments of the alloy according to the present disclosure, the carbon content is at least 0.02 up to 0.2 weight percent, or at least 0.03 up to 0.2 weight percent. It has been observed that a carbon concentration of about 0.03 weight percent minimizes the presence of M₂₃C₆ carbides that may otherwise form during high temperature exposure and produce internal oxidation damage arising from their decomposition. In certain preferred embodiments, carbon content is 0.02 to 0.1 percent, or in some embodiments is 0.03 to 0.06 weight percent or 0.025 to 0.05 weight percent, in order to ensure good high temperature workability and low risk of deleterious melt structures. Carbon contents within the foregoing ranges balance the ability to produce fine grain size for good high cycle fatigue and fatigue crack growth resistance, while ensuring good low cycle fatigue and ultrasonic inspectability.

The grain boundary elements zirconium and boron may be present in embodiments of alloys according to the present disclosure. Zirconium may act as a scavenger for oxygen and sulfur in the alloy. Zirconium, however, can adversely affect weldability and its maximum level should be controlled. In certain embodiments of the alloy according to the present disclosure, the zirconium content is 0 to 0.1 weight percent, greater than 0 to 0.1 weight percent, or 0.001 weight percent to 0.1 weight percent. In various embodiments the zirconium content of alloys herein is 0.001 to 0.05, 0.001 to 0.04, or 0.001 to 0.03 weight percent. Boron may improve grain boundary cohesion and high temperature ductility. Boron, however, can promote formation of grain boundary film, particularly if a high temperature solution treatment temperature is required when processing the alloy. Also, high boron concentrations are known to reduce an alloy's ability to be manufactured by ingot metallurgical practices due to the increased risk for deleterious melt structures. In certain embodiments of the alloy according to the present disclosure, the boron content is 0 to 0.02 weight percent, greater than 0 to 0.02 weight percent, or 0.001 weight percent to 0.02 weight percent. In various embodiments the boron content of alloys herein is 0.001 to 0.015, 0.001 to 0.1, 0.02 to 0.04 weight percent, or 0.002 to 0.01 weight percent.

In various embodiments of the alloys according to the present disclosure, a balance of the alloy includes nickel, trace elements, and impurities. Certain alloy embodiments include at least 33 weight percent nickel. Certain embodiments of alloys according to the present disclosure include at least 36 weight percent nickel, while other embodiments include at least 46 weight percent nickel or at least 48 weight percent nickel. Impurities also may be present, for example, through inclusion in starting materials or as a result of processing of the alloy.

Various non-limiting embodiments of alloys according to the present disclosure include one or more trace elements. As used herein, “trace elements” are elements that may be present in concentrations less than 5 weight percent, or in some cases less than 2 weight percent or less than 1 weight percent, and which either provide some additional advantageous characteristic or property to the alloy or do not significantly affect the important properties or performance of the alloy. Trace elements may be absent in various embodiments of the alloys herein. Examples of trace elements and corresponding maximum contents that optionally may be present in non-limiting embodiments of alloys according to the present disclosure include up to 5.0 weight percent (e.g., up to 4.0, up to 3.0, up to 2.0 weight percent, or greater than 0 to 5.0 weight percent) manganese; up to 0.1 weight percent (e.g., up to 0.05, up to 0.001, up to 0.05 weight percent, greater than 0 to 0.1 weight percent, greater than 0 to 0.05 weight percent, or 0.0001 to 0.1 weight percent) magnesium; up to 1.0 weight percent (e.g., up to 0.8, up to 0.6, up to 0.5 weight percent, or greater than 0 to 1.0 weight percent) silicon; up to 5.0 weight percent (e.g., up to 4.0, up to 3.0, up to 2.0 weight percent, or greater than 0 to 5.0 weight percent) copper; up to 2 weight percent (e.g., up to 1.5, up to 1.0, up to 0.5 weight percent, or greater than 0 to 2 weight percent) vanadium; and/or up a total of 0.2 weight percent (e.g., up to 0.1, up to 0.05, up to 0.03 weight percent, or greater than 0 to 0.2 weight percent) rare earth metals, scandium, and yttrium. Magnesium can enhance melt cleanliness and hot workability.

Examples of elements that may be present as impurities in alloys according to the present disclosure include, for example and without limitation, sodium, magnesium, potassium, calcium, antimony, tin, arsenic, lead, phosphorus, sulfur, fluorine, sulfur, chlorine, oxygen, nitrogen, zinc, and gallium. These impurities elements, if present, typically are present in individual concentrations no greater than about 0.1 weight percent, and the total content of such impurities typically is no greater than 5.0 weight percent.

Increasing a content of gamma-prime phase can increase microstructural stability of the alloy, a characteristic of significant importance in an alloy according to the present disclosure. Increasing gamma-prime content above a particular level, however, can reduce alloy forgeability to an unacceptably low level. The gamma-prime content can be adjusted by, for example, selecting a suitable combined content of aluminum, titanium, tantalum, and niobium in the alloy. For example, nickel-base alloys according to the present disclosure can comprise a combined concentration of aluminum, niobium, and titanium in a range of 5.0 to 7.0 weight percent, such as, for example, 5.0 to 6.0 or 6.0 to 7.0 weight percent. In various non-limiting embodiments, the nickel-base alloys according to the present disclosure can comprise a combined concentration of aluminum and titanium no greater than 7.0 weight percent. For example, the nickel-base alloys according to the present disclosure can comprise a combined concentration of aluminum and titanium in a range of 5.0 to 7.0 weight percent, such as, for example, 5.0 to 6.0 or 6.0 to 7.0 weight percent. In certain non-limiting embodiments, the nickel-base alloys according to the present disclosure have an aluminum equivalent number (Al_{eq}) in the range of 3.6 to 4.5, such as, for example, 3.6 to 4.2 or 4.0 to 4.5.

The chemistry of the gamma-prime phase also may be important in the present alloy. For example, changing the gamma-prime chemistry may alter the lattice parameter of the phase and thereby impact gamma-prime stability. The titanium/aluminum atomic ratio can influence the properties of the gamma-prime phase. A higher titanium level is generally beneficial for mechanical properties, and a higher aluminum level can promote alloy stability. A higher titanium/aluminum atomic ratio, however, may increase Eta phase formation. To balance the influence of titanium and aluminum on the gamma-prime phase in the present alloy, in various embodiments the titanium/aluminum atomic ratio corresponds to a titanium/aluminum weight percentage ratio of 1.2 to 4.0, and in some embodiments the titanium/aluminum weight percentage ratio is 1.5 to 4.0, 2.0 to 4.0, 2.5 to 4.0, 1.5 to 3.0, 1.5 to 2.4, 1.3 to 2.4, 1.7 to 2.2, 3.0 to 4.0, or 1.0 to 2.0.

The addition of niobium also may influence the gamma-prime chemistry. Niobium has a tendency to partition to the gamma-prime phase, increase the gamma-prime phase fraction, and promote gamma-prime formation by reducing solubility of aluminum in the matrix. Niobium also may increase the gamma-prime antiphase boundary energy and subsequently improve creep and tensile properties of the alloy. A higher niobium content in combination with a high titanium content, however, may increase the tendency for formation of Eta phase or other deleterious phases containing niobium and titanium.

Likewise, the addition of tantalum may influence the gamma-prime chemistry. Tantalum tends to partition to the gamma-prime phase, increase the gamma-prime phase fraction, and promote gamma-prime formation by reducing solubility of aluminum in the matrix. Tantalum also may increase the gamma-prime antiphase boundary energy and subsequently improve creep and tensile properties of the alloy. A higher tantalum content combined with a high titanium content, however, may increase the tendency for formation of Eta phase or other phases containing titanium and tantalum.

The present inventors observed that providing a combined concentration of aluminum, niobium, tantalum, and titanium within a certain range in an alloy according to the present disclosure can provide a particularly favorable combination of workability and strength at elevated temperatures. In certain non-limiting embodiments, the nickel-base alloys of this embodiment have an aluminum equivalent number (Al_{eq}) in the range of 3.6 to 4.5, such as, for example, 3.6 to 4.2 or 4.0 to 4.5.

A titanium equivalent/aluminum equivalent ratio (Ti_{eq}/Al_{eq}) can be calculated for alloys according to the present disclosure by the following equation:

Ti_{eq}/Al_{eq}=([Ti]+1.07×[Nb]+0.54×[Ta])/([Al]+0.56×[Ti]+0.3×[Nb]+0.15×[Ta])

wherein [Ti], [Nb], [Ta], and [Al] are the weight percentage contents of the foregoing elements in the alloy. It has been observed that the Ti_{eq}/Al_{eq} ratio value may be used to track the relative stability, resistance to shearing, and lattice parameter of the gamma-prime phase between alloy chemistries. In various embodiments of nickel-base alloys according to the present disclosure, the Ti_{eq}/Al_{eq} is 0.9 to 1.25, such as, for example, 0.9 to 1.0 or 1.0 to 1.25.

Certain non-limiting embodiments of nickel-base alloys according to the present disclosure can be solution treated and/or aged. For example, the nickel-base alloys can be solution treated at a temperature in a range of 1800° F. (982° C.) to 2150° F. (1176° C.) for up to 168 hours, such as, for example 1 hour to 24 hours or 4 hours to 12 hours. In various non-limiting embodiments, the nickel-base alloys can be aged, in either one step or multiple steps, at a temperature in a range of 1400° F. (760° C.) to 1800° F. (982° C.) for up to 72 hours, such as, for example, 1 to 12 hours. The parameters of the aging can be selected without undue experimentation based on the properties of the nickel-base alloy desired after heat treatment.

As is understood in the art, “creep” refers to time-dependent strain occurring under continuous stress below the material's yield strength, such as, for example, at elevated temperature under a load. As used herein in connection with creep properties, “elevated temperature” refers to temperatures in excess of 200° F. (93.3° C.). “Stress rupture” is understood to be the time at which a metallic article ruptures when subjected to a given sustained load at a given temperature. “Creep strength”, also known as “creep limit”, is a measure of a material's resistance to creep. It may also be described as the stress under particular conditions that results in a particular creep rate. In other words, creep strength may be considered the combination of stress, temperature, and time required to reach a particular percent of creep or rupture. The stress rupture for an alloy article is generally indicative of its creep strength. A higher stress rupture value indicates higher creep strength for an alloy article. Embodiment of the nickel-base alloys according to the present disclosure may have an enhanced stress rupture at 1500° F. (816° C.).

Certain non-limiting embodiments of nickel-base alloys according to the present disclosure can exhibit a yield strength in an aged condition at room temperature (e.g., 72° F.+/−2° F.) of at least 120 ksi (827 MPa), such as, for example, at least 125 ksi (862 MPa), at least 130 ksi (896 MPa), at least 135 ksi (931 MPa), at least 140 ksi (965 MPa), or at least 145 ksi (1000 MPa) at room temperature. Tensile properties at room temperature can be determined according to ASTM E8/E8M-16.

Certain non-limiting embodiments of the nickel-base alloys according to the present disclosure can exhibit a yield strength in an aged condition at 1500° F. (816° C.) of at least 90 ksi (621 MPa), such as, for example, at least 95 ksi (655 MPa) at least 100 ksi (689 MPa), or at least 105 ksi (724 MPa). Yield strength at 1500° F. (816° C.) can be measured according to ASTM E21-20.

Certain non-limiting embodiments of the nickel-base alloys according to the present disclosure can exhibit an ultimate tensile strength in an aged condition of at least 180 ksi (1241 MPa), such as, for example, at least 190 ksi (1310 MPa), at least 195 ksi (1344 MPa), at least 200 ksi (1378 MPa), or at least 205 ksi (1413.43 MPa). The ultimate tensile strength can be measured according to ASTM E8/E8M-22.

Certain non-limiting embodiments of the nickel-base alloys according to the present disclosure can exhibit a ultimate tensile strength in an aged condition at 1500° F. (816° C.) of at least 90 ksi (621 MPa), such as, for example, at least 95 ksi (655 MPa), at least 100 ksi (689 MPa), at least 105 ksi (724 MPa), at least 110 ksi (758 MPa), or at least 120 ksi (827 MPa). Ultimate tensile strength at 1500° F. (816° C.) can be measured according to ASTM E21-20.

Certain non-limiting embodiments of the nickel-base alloys according to the present disclosure can exhibit a percent elongation in an aged condition at room temperature in a range of 15% to 40%, such as, for example, 20% to 35% or 25% to 35%. Elongation at room temperature can be measured according to ASTM E8/E8M-22.

Certain non-limiting embodiments of the nickel-base alloys according to the present disclosure can exhibit a percent elongation at 1500° F. (816° C.) in a range of 5% to 30%, such as, for example, 5% to 25%, 10% to 25%, or 15% to 20%. Elongation at 1500° F. (816° C.) can be measured according to ASTM E8/E8M-22.

Alloys according to the present disclosure can be made using conventional ingot metallurgical technologies applied in the production of nickel-based superalloys and which are known to those having ordinary skill. The technologies include, for example, vacuum induction melting, electroslag remelting, vacuum arc remelting, argon oxygen decarburization melting, vacuum oxygen decarburization melting, electric arc furnace, and ladle furnace melting. Other embodiments of the present alloy may be produced in powder form using processes such as, for example, vacuum-melt inert gas atomization (VIGA), electrode inductive gas atomization (EIGA), close-coupled gas atomization, cold-wall inert gas atomization, and rotary electrode process atomization. Subsequent billetization of an ingot may occur by thermomechanical processing, including heat treatments to homogenize, maintain sufficient heat for deformation, and refine microstructure. Mechanical working techniques within said thermomechanical processing that may be applied include, but are not limited to, press forging, radial forging, rotary forging, extrusion, pilgering, swaging, rolling, and drawing. Working of the alloy according to the present disclosure may take place above the temperature of 1500° F. (816° C.), and below the solidus of the material.

Certain non-limiting embodiments of the present nickel-base alloys can be additively manufactured to produce an additively manufactured part. Additive manufacturing refers to a process of joining materials to make objects from three dimensional model data, usually layer upon layer, as opposed to subtractive manufacturing methodologies, and is defined in ASTM F2792-12a, “Standard Terminology for Additively Manufacturing Technologies”. Non-limiting examples of additive manufacturing processes useful in producing products from metallic feedstock include, for instance, DMLS (direct metal laser sintering), SLM (selective laser melting), SLS (selective laser sintering), laser powder bed fusion (LPBF), and EBM (electron beam melting), among others. Any suitable feedstock may be used, including a powder, a wire, and combinations thereof. In some embodiments, the additive manufacturing feedstock is comprised of powder.

Additively manufactured parts that may be made with suitable powder forms of alloys according to the present disclosure may include, but are not limited to, heat exchangers, nose cones, scramjet engine components, vehicle leading edges, heat pipes, reentry structures, actively or passively cooled controlled surfaces, vehicle skins, a component of a RAM-jet, a component of a rocket motor, a component of a combined cycle motor, a component of a rotary detonation motor, a component of gasification equipment, a component of chemical processing equipment, and a component of a fastening system.

Non-limiting examples follow below.

### EXAMPLE 1

Several experimental “button” samples, each weighing approximately 500 grams, were prepared, rolled, heat treated, and tested for tensile properties. Table 1 provides the target composition of the experimental samples, referenced as W6, W11-W13, W20-W22, and W24-W26, and the target composition of a Waspaloy sample, W0, made for comparison purposes. The samples also would have included incidental impurities. Table 1 also lists predicted values for density, gamma-prime volume percent contents at 1000° F. (538° C.) and 1500° F. (816° C.), and gamma-prime solvus temperature, all calculated using JMatPro software version 4-1.

Each button was cold rolled to a thickness of approximately 0.15 inch and heat treated as follows. It was observed that none of the buttons cracked during rolling. The rolled buttons were subjected to a solution treatment at 2000° F. (1093° C.) for 2 hours and individually water quenched. The solutioned buttons were subjected to a first aging step at 1650° F. (890° C.) for 4 hours, air cooled, and then subjected to a second aging step at 1550° F. (843° C.) for 12 hours and air cooled. The solution treated and aged rolled buttons were tested for tensile properties at room temperature according to ASTM E8-16ae1, and also at 1500° F. (816° C.) according to ASTM E21-17e1. Tested properties included ultimate tensile strength, 0.2% yield strength, elongation, and reduction in area. The tensile testing results are reported in Table 2 (tensile test samples at room temperature) and Table 3 (tensile test samples at 1500° F. (816° C.)). The heated tensile test samples were allowed to soak at 1500° F. (816° C.) for 30 minutes before tensile testing.

The sample W12 tensile test sample tested at 1500° F. (816° C.) had suspect strain for testing and, therefore, the yield could not be reported. The reported UTS for sample W12 tested at 1500° F. (816° C.), however, is believed to be valid and is reported. The tensile test sample for sample W13 tested at 1500° F. (816° C.) became stuck in the clevis post-testing and was destroyed during its removal, and the elongation and reduction in area (RA) were not obtained for that sample.

| | | | | | | | | | | | | | Prime | Prime | Prime |
|---|---|---|---|---|---|---|---|---|---|---|---|---|---|---|---|
| | | | | | | | | | | | | | [symbol] | [symbol] | Solvus |
| | | | | | | | | | | | | | at | at | Temp |
| | | | | | | | | | | | | Density | 1000° F. | 1500° F. | ° F. |
| [symbol] | Ti | Al | Nb | W | Mo | Fe | Ta | Zr | B | N | Ni | (g/cm³) | (vol. %) | (vol. %) | (° C.) |
| | 3 | 1.4 | 0 | 0 | 4.3 | 1.2 | 0 | 0.05 | 0.006 | 0.005 | 56.96 | 8.23 | 25 | 21 | 1859 |
| | | | | | | | | | | | | | | | (1015) |
| | 3.2 | 1.8 | 0.75 | 1.5 | 4.3 | 1.2 | 0 | 0.035 | 0.0060 | 0.005 | 54.17 | 8.24 | 33 | 28 | 1888 |
| | | | | | | | | | | | | | | | (1067) |
| | 2.85 | 1.65 | 0.75 | 2 | 4 | 1.2 | 0 | 0.035 | 0.0060 | 0.005 | 56.47 | 8.33 | 30 | 24.5 | 1931 |
| | | | | | | | | | | | | | | | (1055) |
| | 2.85 | 1.65 | 0.75 | 4 | 4 | 1.2 | 0 | 0.035 | 0.0060 | 0.005 | 53.47 | 8.42 | 30 | 24.5 | 1907 |
| | | | | | | | | | | | | | | | (1058) |
| | 3.5 | 2 | 0.75 | 2 | 4 | | | | | | | | | | |
| | 3.5 | 2 | 0.75 | 3 | 3 | | | | | | | | | | |
| | 3.5 | 2 | 0.75 | 2.5 | 2.5 | 1.2 | 0 | 0.035 | 0.0060 | 0.005 | 54.47 | 8.29 | 36 | 30.5 | 2005 |
| | | | | | | | | | | | | | | | (1056) |
| | 3.5 | 2 | 0.75 | 1.5 | 3.5 | 1.2 | 0 | 0.035 | 0.0060 | 0.005 | 54.47 | 8.27 | 35 | 30.5 | 2000 |
| | | | | | | | | | | | | | | | (1096) |
| | 2.85 | 1.65 | 0.75 | 0 | 6 | 1.2 | 0 | 0.035 | 0.0060 | 0.005 | 54.47 | 8.31 | 29 | 23 | 1911 |
| | | | | | | | | | | | | | | | (1044) |
| | 2.85 | 1.65 | 0.75 | 2.5 | 2.5 | 1.2 | 1 | 0.035 | 0.0060 | 0.005 | 54.48 | 8.41 | 31 | 25 | 1912 |
| | | | | | | | | | | | | | | | (1044) |
| | 2.85 | 1.65 | 0.75 | 2.5 | 2.5 | 1.2 | 2 | 0.035 | 0.0060 | 0.005 | 53.48 | 8.43 | 33 | 27 | 1920 |
| | | | | | | | | | | | | | | | (1049) |

[symbol]

indicates data missing or illegible when filed

TABLE 2
Tensile Test Results (Room Temperature)

| | Test | UTS | 0.2% | | |
|---|---|---|---|---|---|
| Sample | Temp. | ksi | YS ksi | Elong. | RA |
| No. | (° F.) | (MPa) | (MPa) | (%) | (%) |
| W0 | Room | 178.0 | 109.1 | 28 | 30 |
| W6 | Room | 192.9 | 111.6 | 30 | 20 |
| W11 | Room | 166.4 | 115.6 | 10 | 11 |
| W12 | Room | 135.2 | 86.7 | 12 | 11 |
| W13 | Room | 155.4 | 125.8 | 7.0 | 8.5 |
| W20 | Room | 144.6 | 115.3 | 8.0 | 6.0 |
| W21 | Room | 190.0 | 129.4 | 17 | 14 |
| W22 | Room | 152.3 | 121.1 | 10 | 5.5 |
| W24 | Room | 157.5 | 107.1 | 13 | 10 |
| W25 | Room | 144.6 | 114.7 | 9.0 | 22 |
| W26 | Room | 181.9 | 128.8 | 9.0 | 8.5 |

TABLE 3
Tensile Test Results (1500° F.)

| | Test | UTS | 0.2% | | |
|---|---|---|---|---|---|
| Sample | Temp. | ksi | YS ksi | Elong. | RA |
| No. | (° F.) | (MPa) | (MPa) | (%) | (%) |
| W0 | 1500 | 80.9 | 77.8 | 24.0 | 45.0 |
| W6 | 1500 | 97.7 | 92.1 | 1.5 | 3.5 |
| W12 | 1500 | 92.2 | — | — | — |
| W13 | 1500 | 115.5 | 114.2 | — | — |
| W21 | 1500 | 89.4 | 89.2 | 2.0 | 1.5 |
| W24 | 1500 | 68.4 | 67.8 | 1.0 | 0.5 |
| W25 | 1500 | 88.7 | — | 0.0 | 0.0 |
| W26 | 1500 | 87.3 | 86.1 | 2.0 | 1.0 |

### EXAMPLE 2

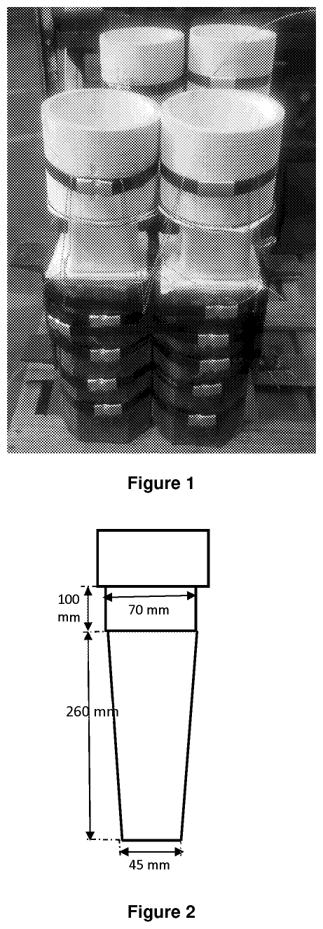

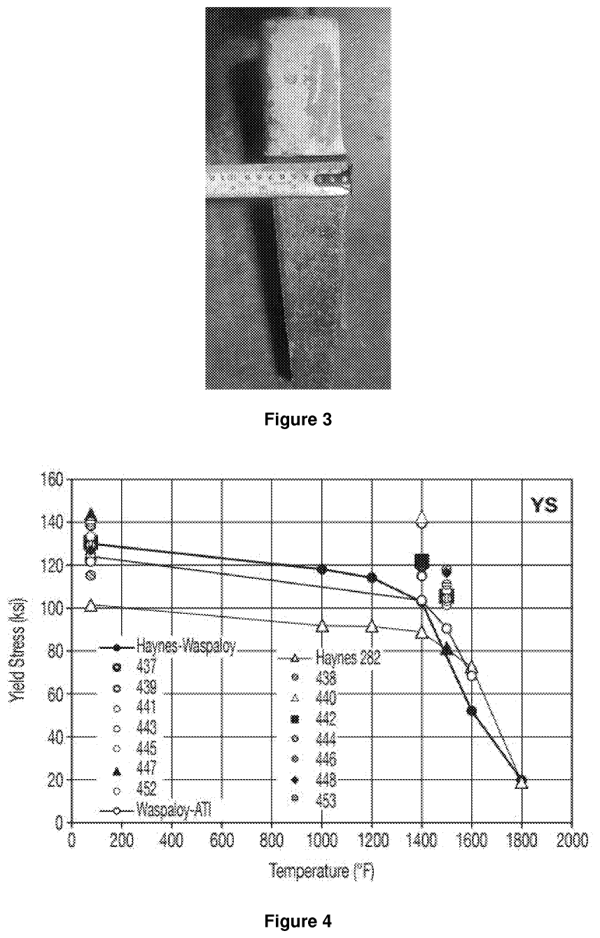

Several 25 lb. heats of nickel-base alloys with different chemistries were melted via vacuum induction melting and poured into tapered twin metallic molds. The chemical composition of each heat is shown in Table 3. The values in Table 3 are weight percentages based on total weight of the alloy. FIG. 1 is a photograph showing the twin VIM mold setup used to cast the 25 lb. heats in this example. FIG. 2 shows dimensions of the VIM mold setup used to cast the 25 lb. heats in this example. FIG. 3 is a photograph showing a representative cast 25 lb. heat made in this example. Each heat was homogenized at higher temperature to equalize any possible chemical variation that may have occurred during solidification.

| | B | C | Co | Cr | Fe | Mo | Nb | Ni | Si | Ta | [symbol] | [symbol] | Zr |
|---|---|---|---|---|---|---|---|---|---|---|---|---|---|
| [symbol] 95 | 0.0059 | 0.04 | 18.125 | 16.04 | 2.1 | 6.101 | 0.004 | 50.0203 | 0.036 | 0.008 | 3.573 | 2.041 | 0.032 |
| 39 | 0.0057 | 0.035 | 17.86 | 15.92 | 1.984 | 4.007 | 0.501 | 51.4317 | 0.021 | 0.997 | 3.493 | 1.992 | 0.031 |
| 47 | NA | 0.046 | 17.991 | 15.968 | 2.011 | 2.132 | 0.495 | 61.1094 | 0.02 | 0.985 | 3.468 | 4.013 | 0.037 |
| 25 | 0.0061 | 0.017 | 18.064 | 16.018 | 2.004 | 2.99 | 0.492 | 61.1609 | 0.018 | 0.981 | 3.456 | 3.037 | 0.03 |
| 1 | 0.0046 | 0.024 | 18.032 | 16.991 | 2.001 | 3.994 | 0.496 | 61.8418 | 0.018 | 0.993 | 3.028 | 2.043 | 0.03 |
| 08 | 0.0061 | 0.038 | 18.088 | 15.978 | 1.994 | 3.098 | 0.501 | 51.8259 | 0.02 | 0.992 | 2.977 | 2.962 | 0.03 |
| 16 | 0.0059 | 0.043 | 25.379 | 16.285 | 1.978 | 3.568 | 0 | | | | | | |
| 91 | 0.0043 | 0.042 | 19.487 | 14.17 | 2.009 | 5.98 | 0.007 | 50.231 | 0.017 | 1.005 | 3.282 | 1.968 | 0.031 |
| 3 | 0.0055 | 0.04 | 25 434 | 14.847 | 2.002 | 3.655 | 0.004 | 47.2957 | 0.03 | 0.082 | 4.876 | 0.197 | 0.029 |
| 96 | 0.0052 | 0.044 | 27.809 | 14.885 | 1.993 | 5.764 | 0.003 | 43.5545 | 0.027 | 0.01 | 4.386 | 0.021 | 0.03 |
| 59 | 0.006 | 0.044 | 28.323 | 14.858 | 2.027 | 7.942 | 0.003 | 41.5386 | 0.022 | 0.005 | 5.951 | 0.005 | 0.034 |
| 67 | 0.0064 | 0.046 | 22.684 | 15.932 | 2.05 | 6.441 | 0.004 | 44.482 | 0.019 | 0.005 | 5.075 | 0.004 | 0.006 |
| 98 | 0.0039 | 0.03 | 26.938 | 16.912 | 2.031 | 3.679 | 0.002 | 43.864 | 0.018 | 0.005 | 4.116 | 2.653 | 0.027 |
| 01 | 0.0042 | 0.028 | 25.968 | 16.202 | 2.018 | 3.982 | 0.003 | 41.861 | 0.016 | 0.007 | 4.166 | 3.985 | 0.031 |

[symbol]

indicates data missing or illegible when filed

The chemistry of each of the heats listed in Table 3 was selected to include alloying elements adjusting gamma-prime content to levels greater than in certain conventional high temperature nickel-base alloys (e.g., Waspaloy, 718, and GTD222 alloys), and the Al_{eq} of the alloy was controlled to ensure that the gamma-prime content was low enough to ensure acceptable workability. In heat nos. P0F00 to P0F03, the contents of molybdenum, tungsten, tantalum, and niobium were varied. Molybdenum and tungsten are substitutional elements that may improve high temperature mechanical properties. Tungsten and molybdenum also can increase the lattice parameter of the matrix phase and, as a result, minimize lattice mismatch between gamma-prime and matrix phases, which in turn reduces the coarsening rate of the gamma-prime phase. Tantalum and niobium, however, can form carbides and partition to the gamma-prime precipitates and could improve stress rupture properties. Adding too high a content of tantalum and/or niobium could increase the susceptibility of the alloy to form Eta phase (NiTi₃) or other deleterious secondary phases. In heat nos. P0F04 and P0F05 the aluminum and titanium contents were reduced and the molybdenum and tungsten contents were adjusted to avoid TCP phase formation. To better ensure that the alloys were ring rollable and had good workability, the gamma-prime solvus was kept under or near 2050° F. (1121° C.).

Chromium was included in the heats to provide oxidation resistance, but was limited so that alloy microstructure did not become unstable leading to formation of TCP phases. Cobalt can lower stacking fault energy and also increase solubility of aluminum and titanium in the matrix, improving workability of the alloy. Grain boundary elements including boron and zirconium were present to improve fatigue crack growth rate, high temperature ductility, and weldability of the alloys. Boron and zirconium contents were limited, given that excessive amounts of those elements could result in grain boundary film formation at higher temperatures during solution treatment.

The carbon level in the heats was selected to minimize the presence of M₂₃C₆ carbides that may form during high temperature exposure and produce possible internal oxidation damage when they decompose. It was observed that, for example, controlling carbon content to 0.040 to 0.05 weight percent can be effective in controlling grain growth through grain boundary pinning during super-solvus solution heat treatment. Although increasing the carbon content in the alloy composition could produce a smaller average grain size, it also may lower workability and low cycle fatigue performance of the alloy due to formation of carbonitride stringers.

Table 4 provides gamma-prime solvus temperatures and aluminum equivalent numbers for the heats listed in Table 3. Gamma-prime solvus temperatures were measured by a differential thermal analysis (DTA) technique. To better ensure sufficient workability, the gamma-prime solvus temperature preferably is below 2050° F., and more preferably is below 1950° F., so that gamma-prime precipitation does not occur on the surface of material as it is being ring rolled. Gamma-prime content of alloys according to the present disclosure can be influenced by suitably adjusting the aluminum equivalent number of the alloys. The aluminum number (Al_{eq}), for purposes of the present disclosure, is calculated by the following equation, in which [Al], [Ti], [Nb], and [Ta] are weight percentage concentrations of the elements in the alloy:

$${Al}_{eq} = [ Al ] + 0.56 \times [ Ti ] + 0.3 \times [ Nb ] + 0.15 \times [ Ta ]$$

The preset inventor has determined that alloys according to the present disclosure having an aluminum equivalent number in a range of 3.6 to 4.5 can have advantageous workability properties and a gamma-prime content at high temperatures, e.g., greater than 1200° F. (649° C.), that is advantageous in structural parts subjected to stress at those high temperatures.

TABLE 4
Gamma-prime Solvus Temperatures

| | Gamma-prime Solvus | Aluminum Equivalent |
|---|---|---|
| Heat # | Temperature | (Weight Percent) |
| P0F00 | 1976° F. (1080° C.) | 3.898 |
| P0F01 | 1985° F. (1085° C.) | 3.995 |
| P0F02 | 1991° F. (1088° C.) | 3.985 |
| P0F03 | 1992° F. (1089° C.) | 3.955 |
| P0F04 | 1938° F. (1059° C.) | 3.503 |
| P0F05 | 1936° F. (1058° C.) | 3.474 |
| P0F06 | 2003° F. (1095° C.) | 4.286 |
| P0F07 | 1969° F. (1076° C.) | 3.781 |
| P0F08 | 2004° F. (1096° C.) | 4.274 |
| P0F09 | 1964° F. (1073° C.) | 3.955 |
| P0F10 | 2037° F. (1114° C.) | 4.593 |
| P0F11 | 2007° F. (1097° C.) | 4.111 |
| P0F12 | 1974° F. (1079° C.) | 4.004 |
| P0F13 | 1982° F. (1083° C.) | 4.036 |

The VIM samples were subjected to forging and then a super-solvus solution treatment and a two-step age. After heat treatment, samples were prepared from each heat and were subjected to tensile and stress rupture tests under various test conditions. The test conditions are shown in Table 5, and the test results are shown in Tables 6-10, as follows. Table 6 lists tensile test results (yield strength, ultimate tensile strength, percent elongation (% El), and percent reduction in area (% RA)) evaluated at room temperature. Table 7 lists tensile test results evaluated at 1500° F. (816.6° C.). Table 8 lists stress rupture test results for certain of the heats, evaluated at 1500° F. (816.6° C.) and 40 ksi (275.8 MPa).

TABLE 5
Mechanical Test Conditions

| Test | Condition |
|---|---|
| Tensile | Room temperature and 1500° F. (816.6° C.) |
| Stress Rupture | 1500° F. (816.6° C.)/40 ksi (275.8 MPa) |
| | 1500° F. (816.6° C.)/50 ksi (344.7 MPa) |
| | 1500° F. (816.6° C.)/60 ksi (413.7 MPa) |

TABLE 6
Tensile Properties at Room Temperature

| | YS | UTS | | |
|---|---|---|---|---|
| Heat # | ksi (MPa) | ksi (MPa) | % El | % RA |
| P0F00 | 122.4 | 192 | 17.4 | 15.8 |
| | (843.9) | (1323) | | |
| P0F01 | 126.8 | 195.5 | 15.9 | 15.3 |
| | (874.2) | (1347) | | |
| P0F02 | 131.4 | 197.6 | 14.2 | 12.7 |
| | (906.0) | (1362) | | |
| P0F03 | 122.9 | 189.7 | 22 | 22.2 |
| | (847.4) | (1308) | | |
| P0F04 | 121.5 | 194.3 | 24.1 | 21.1 |
| | (837.7) | (1340) | | |
| P0F05 | 130.2 | 190.2 | 15.2 | 15.9 |
| | (897.7) | (1311) | | |
| P0F06 | 127.2 | 195.89 | 17.8 | 15.1 |
| | (877.0) | (1351) | | |
| P0F07 | 115 | 190.73 | 33 | NA |
| | (792.9) | (1315) | | |
| P0F08 | 133 | 198.43 | 15.8 | NA |
| | (917.0) | (1368) | | |
| P0F09 | 129 | 193.8 | 17.5 | 18.1 |
| | (889.4) | (1336) | | |
| P0F10 | 143.3 | 184.7 | 4.5 | 5.3 |
| | (988.0) | (1273) | | |
| P0F11 | 126.5 | 183.6 | 9.5 | 11.1 |
| | (872.2) | (1266) | | |
| P0F12 | 138.6 | 204.5 | 24.6 | 20.2 |
| | (955.6) | (1410) | | |
| P0F13 | 139.8 | 197.3 | 18.8 | 18.5 |
| | (963.9) | (1360) | | |

TABLE 7
Tensile Properties at 1500° F. (816.6° C.)

| | YS | UTS | | |
|---|---|---|---|---|
| Heat # | ksi (MPa) | ksi (MPa) | % El | % RA |
| P0F00 | 108.1 | 123.9 | 13 | 11.5 |
| | (745.3) | (854.2) | | |
| P0F01 | 117.5 | 117.7 | 3 | 5 |
| | (810.1) | (811.5) | | |
| P0F02 | 107 | 118.6 | 2 | 4 |
| | (737.7) | (817.7) | | |
| P0F04 | 105.3 | 107.3 | 3 | 9 |
| | (726.0) | (739.8) | | |
| P0F05 | 105.3 | 105.3 | 4 | 7.5 |
| | (726.0) | (726.0) | | |
| P0F06 | 101.4 | 117.25 | 3.7 | 5 |
| | (699.1) | (808.4) | | |
| P0F07 | 104.56 | 117.61 | 4.4 | 4.1 |
| | (720.9) | (810.9) | | |
| P0F08 | 103.49 | 117.92 | 11.2 | 4.5 |
| | (713.5) | (813.0) | | |
| P0F09 | 104.5 | 106.9 | 2 | 3.5 |
| | (720.5) | (737.0) | | |
| P0F10 | 81 | 107 | 49 | 50 |
| | (558.5) | (737.7) | | |
| P0F11 | 116.3 | 132.1 | 5 | 7.2 |
| | (801.9) | (910.7) | | |
| P0F12 | 108.5 | 112.2 | 4 | 7.6 |
| | (748.0) | (773.6) | | |
| P0F13 | 110.6 | 115.3 | 2 | 4.9 |
| | (762.5) | (795.0) | | |

TABLE 8
Stress Rupture Results at 1500° F. (816.6° C.)/40 ksi (275.8 MPa)

| Heat # | Rupture time (hr) | % El |
|---|---|---|
| P0F01 | 565 | 9.6 |
| P0F05 | 1005 | 6.9 |
| P0F06 | 445 | 8.6 |
| P0F07 | 251 | 7.6 |
| P0F08 | 357 | 5 |
| P0F11 | 309.3 | 30 |

Yield strength and ultimate tensile strength were determined for certain of the 25 lb. heats in this Example 2 at 1400° F. (760.0° C.) and 1600° F. (871.1° C.). Elongation and reduction in area were measured at 1400° F. (760.0° C.) for certain of the heats. Tensile properties measured at 1400° F. (760.0° C.) for certain of the 25 lb. heats are included in Table 9.

TABLE 9
Tensile Properties at 1400° F. (760.0° C.)

| | YS | UTS | | |
|---|---|---|---|---|
| Heat # | ksi (MPa) | ksi (MPa) | % El | % RA |
| P0F00 | 118.7 | 151.5 | 17 | 13.2 |
| | (818.4) | (1044.6) | | |
| P0F02 | 139.3 | 154.8 | 7.5 | 7.5 |
| | (960.4) | (1067.3) | | |
| P0F03 | 142.5 | 159.2 | 8 | 9.8 |
| | (982.5) | (1097.6) | | |
| P0F05 | 121.3 | 136.4 | 8.1 | 9.4 |
| | (836.3) | (940.4) | | |
| P0F12 | 114.7 | 137.6 | 8 | 14.7 |
| | (790.8) | (948.0) | | |

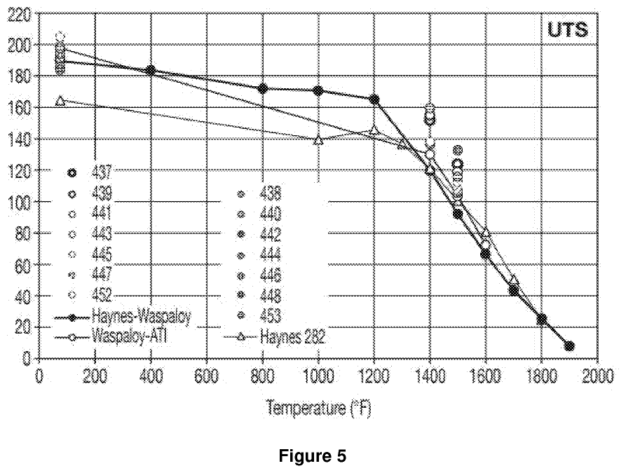

FIG. 4 is a plot of yield strength (ksi) as a function of test temperature (measured at room temperature and at 1400° F. (760.0° C.), 1500° F. (816.6° C.), and 1600° F. (871.1° C.)) for the heats (batch numbers provided), and also plots yield strength at various temperatures for the commercial nickel-base alloys Haynes Waspaloy alloy, ATI Waspaloy alloy, and Haynes 282 alloy. FIG. 5 is a plot showing ultimate tensile strength (ksi) as a function of test temperature for the heats made in this Example 1 (batch numbers provided), and also plots ultimate tensile strength at various temperatures for the Haynes Waspaloy alloy, ATI Waspaloy alloy, and Haynes 282 alloy (UNS N07208). The alloys were observed to be similar to Waspaloy alloy in forgeability, while performing at a significant advantage over Waspaloy alloy at 1500° F. (816.6° C.).

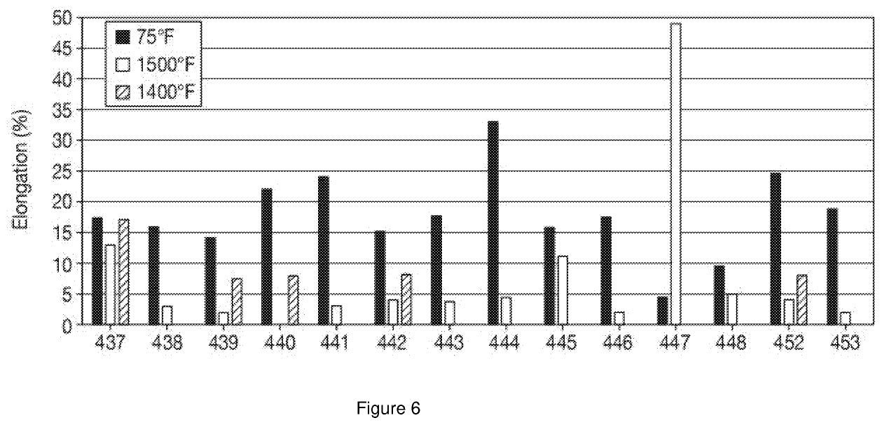

In addition to testing at room temperature and 1500° F. (816.6° C.), elongation was evaluated at 1400° F. (760.0° C.) for the 25 lb. heats. FIG. 6 plots elongation versus test temperature for each of the heats (batch numbers listed).

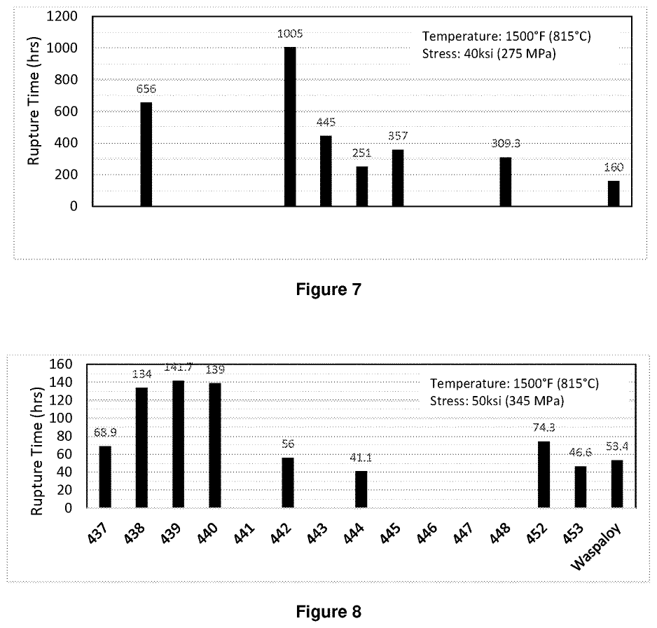

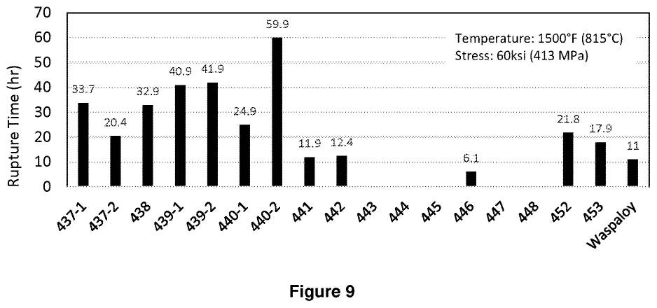

Stress rupture testing at 1500° F. (816.6° C.) and 40 ksi (275.8 MPa) was performed on only certain of the heats due to the very long stress rupture times. After running stress rupture tests at 1500° F. (816.6° C.) and 40 ksi (275.8 MPa) on some of the chemistries, the stress rupture test conditions were changed to 1500° F. (816.6° C.)/50 ksi (344.7 MPa) and 1500° F. (816.6° C.)/60 ksi (413.7 MPa). The results for testing under those additional conditions are shown in in Tables 10 and 11, respectively. FIGS. 7-9 plot the stress rupture results for each of the test conditions. As expected, stress rupture times at higher stresses were generally shorter. Tables 10 and 11 also provide stress rupture time and elongation results under the indicated test conditions for a Waspaloy alloy production material that had been heat treated by the following sequence of steps: (1) heat at 1975° F. (1079° C.) for 4 hours and air cool; (2) heat at 1550° F. (843° C.) for 24 hours and air cool; and (3) heat at 1400° F. (760° C.) for 16 hours and air cool.

TABLE 10
Stress Rupture Results at 1500° F. (816.6° C.)/50 ksi (344.7 MPa)

| Heat # | Rupture time (hr) | % El |
|---|---|---|
| P0F00 | 68.9 | 30.5 |
| P0F01 | 134 | 11.6 |
| P0F02 | 141.7 | 8 |
| P0F03 | 139 | 7.4 |
| P0F05 | 56 | 9.9 |
| P0F07 | 41.1 | 14.9 |
| P0F12 | 74.3 | 11.8 |
| P0F13 | 46.6 | No Data |
| Waspaloy | 53.4 | 38.2 |

TABLE 11
Stress Rupture Results at 1500° F. (816.6° C.)/60 ksi (413.7 MPa)

| Heat # | Test Run # | Rupture life (hr) | % El |
|---|---|---|---|
| P0F00 | 1 | 33.7 | 14.9 |
| | 2 | 20.4 | 19.6 |
| P0F01 | 1 | 32.9 | 7.2 |
| P0F02 | 1 | 40.9 | 8.1 |
| | 2 | 41.9 | 10.3 |
| P0F03 | 1 | 24.9 | 4.7 |
| | 2 | 59.9 | 10.5 |
| P0F04 | 1 | 11.9 | 2 |
| P0F05 | 1 | 12.4 | 7.3 |
| P0F09 | 1 | 6.1 | No Data |
| P0F12 | 1 | 21.8 | 7.6 |
| P0F13 | 1 | 17.9 | 6 |
| Waspaloy | 1 | 11 | 37.8 |

### EXAMPLE 3

After considering mechanical and microstructural results for the 25 lb. heats of Example 2, seven 300 lb. experimental heats (P0F15 through P0F19) were melted via vacuum induction melting followed by remelting using vacuum arc remelting. Table 12 provides the chemical composition of each of the 300 lb. heats, wherein all contents are weight percentages based on total weight of the alloy heat.

| [symbol] | B | C | Co | Cr | Fe | Mo | Nb | Ni | Si | Ta | [symbol] | W | Zr |
|---|---|---|---|---|---|---|---|---|---|---|---|---|---|
| | 0.0049 | 0.014 | 26.282 | 16.051 | 2.02 | 3.513 | 0.002 | 44.8936 | 0.01 | 0.008 | 3.994 | 2.456 | 0.031 |
| | 0.0058 | 0.028 | 18.271 | 15.864 | 2.03 | 5.98 | 0.004 | 50.4552 | 0.013 | 0.015 | 3.581 | 1.99 | 0.031 |
| | 0.0055 | 0.026 | 16.131 | 15.102 | 2.019 | 3.099 | 0.474 | 54.0562 | 0.015 | 0.935 | 3.457 | 2.951 | 0.028 |
| | 0.0058 | 0.017 | 17.916 | 13.899 | 2.02 | 2.544 | 0.725 | 52.8962 | 0.019 | 1.404 | 3.079 | 3.49 | 0.031 |
| | 0.006 | 0.018 | 17.712 | 11.665 | 1.958 | 2.937 | 0.704 | 51.8678 | 0.02 | 1.264 | 2.803 | 5.653 | 0.025 |
| | 0.0056 | 0.02 | 17.906 | 11.923 | 1.98 | 3.022 | 0.732 | 52.732 | 0.021 | 1.395 | 2.516 | 5.806 | 0.024 |
| | 0.0059 | 0.022 | 18.018 | 14.054 | 1.974 | 2.045 | 0.715 | 52.5589 | 0.019 | 1.393 | 3.457 | 4.013 | 0.032 |

[symbol]

indicates data missing or illegible when filed

Heat P0F14 included a relatively high cobalt content which increased titanium solubility, preventing it from participating in TCP phase formation. This also allowed for a relatively high titanium/aluminum ratio, which provided advantageous tensile properties (high strength and ductility at room temperature). Tungsten content in heat P0F18 was relatively high, and chromium content was reduced as compared with P0F14. The lower chromium content reduced likelihood of sigma phase precipitation and improved the solubility limits for tungsten and molybdenum in heat P0F18. Heat P0F19 was similar to heat P0F16 but included higher tungsten and lower molybdenum contents, which may improve creep properties and potentially reduce propensity to form TCP phase.

The gamma-prime solvus temperature of heat Nos. P0F14 through P0F19 was determined by DTA and the results are shown in Table 13. As previously discussed, the preferred gamma-prime solvus for the alloy according to the present disclosure is at or below 2050° F., and in Table 10 all but the results for heat no. P0F19 satisfy that preferred characteristic.

TABLE 13
Gamma-prime Solvus Temperatures

| | DTA analysis |
|---|---|
| Heat # | ° F. (° C.) |
| P0F14 | 1966 (1074) |
| P0F15 | 1965 (1074) |
| P0F16 | 1993 (1089) |
| P0F17 | 1890 (1032) |
| P0F18 | 1970 (1077) |
| P0F19 | 2003 (1095) |

After homogenization, the alloy samples were heat treated. Table 14 provides steps of the heat treatments applied to the heats. “AC” refers to air cool in Table 14.

TABLE 14
Heat treatments

| | |
|---|---|
| A | 2050° F. (1121° C.)/30 minutes/AC + 1650° F. |
| | (899° C.)/4 hrs/AC |
| B | ~50° F. (27.8° C.) under solvus/2 hrs/oil quench + 1550° F. |
| | (843° C.)/4 hrs/AC + 1450° F. (787° C.)/8 hrs/AC |
| C | 1975° F.(1079° C.)/4 hrs/AC + 1550° F.(843° C.)/24 |
| | hrs/AC + 1400° F.(760° C.)/16 hrs/AC |
| D | 1825° F. (996° C.)/4 hrs/oil quench + 1550° F. (843° C.)/ |
| | 4 hrs/AC + 1400° F./16 hrs/AC |
| E | 1925° F. (996° C.)/4 hrs/oil quench + 1550° F. (843° C.)/ |
| | 24 hrs/AC + 1400° F./16 hrs/AC |

Test samples were prepared from the heat treated alloys and tested for tensile and formability properties at various test sample temperatures. The tensile and formability test results are presented in Table 15. Heat treated production samples of Waspaloy alloy also were tested and the results appear in Table 15.

TABLE 15
Tensile and formability test results

| | Heat | Test | | 0.2% | | | |
|---|---|---|---|---|---|---|---|
| | Treat- | Temper- | UTS | YS | 4D | 5D | RA |
| Heat | ment | ature | (ksi) | (ksi) | (%) | (%) | (%) |
| P0F14 | B | RT^{a} | 205.9 | 124.0 | 24 | — | 31.3 |
| | A | 1400 | 134.6 | 115.5 | 3.0 | 1 | 9.5 |
| | A | 1500 | 110.4 | 108.5 | 0.0^{b} | 0 | 4.0 |
| | B | 1500 | 110.9 | 107.6 | 4.0 | 6.5 | 7.5 |
| | B | 1600 | 88.3 | 86.3 | 4.0 | 3 | 5.0 |
| P0F15 | B | RT | 198.7 | 133.1 | 28.0 | — | 25.0 |
| | A | 1500 | 124.6 | 108.2 | 6.0 | 5.0 | 5.5 |
| | A | 1600 | 92.7 | 88.8 | 7.0 | 6.5 | 10.0 |
| | B | 1500 | 146 | 109.9 | 10.0 | 12.0 | 11.0 |
| | B | 1600 | 112.7 | 100.1 | 7.0 | 8.0 | 10.5 |
| P0F16 | B | RT | 205.5 | 144.9 | 37.3 | — | 27.5 |
| | B | 1500 | 136 | 118.9 | 5.0 | 4.0 | 8.0 |
| | B | 1600 | 99.6 | —^{c} | 3.0 | 2.5 | 3.5 |
| P0F17 | B | RT | 229.2 | 175.9 | 23.9 | — | 33.4 |
| | B | 1500 | 139.9 | 102.5 | 19.0 | 19.0 | 24.5 |
| | B | 1600 | 93.2 | 75.4 | 3.0 | 10.5 | 9.5 |
| P0F18 | B | RT | 201.4 | 142.0 | 29.1 | — | 34.7 |
| | B | 1500 | 117.7 | 116.9 | 3.0 | 4.0 | 8.0 |
| | B | 1600 | 99.7 | 98.5 | 2.5 | 3.0 | 3.0 |
| P0F19 | B | RT | 207.5 | 151.0 | 17.1 | — | 19.9 |
| | B | 1500 | 125.3 | 122.1 | 3.0 | 3.0 | 3.5 |
| | B | 1600 | 99.5 | 99.3 | 4.0 | 3.0 | 4.0 |
| Waspaloy | D | RT | 197.2 | 124 | 24 | — | 28 |
| | D | 1400 | 129.6 | 103.3 | 39 | — | 62 |
| | D | 1500 | 102.9 | 90.3 | 42 | — | 67 |
| | D | 1600 | 71.9 | 68.1 | 27 | — | 68.5 |
| | E | RT | 191.2 | 123.2 | 25 | — | 28 |
| | E | 1400 | 121.6 | 102.3 | 37 | — | 53.5 |
| | E | 1500 | 101 | 90.1 | 42 | — | 67.5 |
| | E | 1600 | 73 | 67 | 47 | — | 67 |

^{a}Room temperature (~75° F.)
^{b}Fractured outside gauge length
^{c}YS not obtained; fractured before reaching 0.2% offset

Samples of the heat treated alloys and Waspaloy alloy production material also were tested for elevated temperature stress rupture time and elongation at a sample temperature of 1500° F. (816° C.) and with applied stress of 50 ksi (345 MPa) or 60 ksi (414 MPa). The test results are shown in Table 16.

TABLE 16
Stress rupture and elongation test results

| | Heat | Test | Stress | | |
|---|---|---|---|---|---|
| | Treat- | Temperature | Level | Time | Elongation |
| Heat | ment | (° F.) | (ksi) | (hours) | (%) |
| P0F14 | B | 1500 | 50 | 54.7 | 3.1 |
| | B | 1500 | 60 | 11.7 | 2.4 |
| P0F15 | A | 1500 | 50 | 122 | 34.6 |
| | A | 1500 | 60 | 99.3 | 24.4 |
| | B | 1500 | 60 | 33.6 | 25.2 |
| P0F16 | B | 1500 | 50 | 199.9 | 4.4 |
| | B | 1500 | 60 | 53.1 | 1.5 |
| P0F17 | B | 1500 | 50 | 57.8 | 18.1 |
| | B | 1500 | 60 | 26.6 | 13.3 |
| P0F18 | B | 1500 | 50 | 167.2 | 2.9 |
| | B | 1500 | 60 | Unloaded | |
| | | | | before rupture | |
| P0F19 | B | 1500 | 50 | 88.2 | 1.6 |
| Waspaloy | C | 1500 | 50 | 53.4 | 38.2 |
| | C | 1500 | 60 | 11 | 37.8 |

All of the experimental alloys in this example exhibited significantly improved creep rupture properties and tensile strengths relative to Waspaloy.

### EXAMPLE 4

Nickel-base alloy heats having the chemistries listed in Table 17 were prepared by vacuum induction melting feed materials. The values in Table 17 are weight percentages based on total alloy weight. “NM” signifies that a content was not measured. Each alloy heat also included incidental impurities and balance nickel. The heats were gas atomized to form metallurgical powders.

| [symbol] | C | Co | Cr | Fe | Mo |
|---|---|---|---|---|---|
| 4 | 0.049 | 24.11 | 16.16 | 2 | 3.58 |
| 49 | 0.047 | 24.137 | 16.603 | 2.058 | 3.666 |
| 6 | 0.053 | 17.97 | 15.94 | 2 | 2.99 |
| 48 | 0.051 | 18.235 | 16.028 | 1.996 | 3.034 |

| Nb | Ta | Ti | W | Zr |
|---|---|---|---|---|
| NM | NM | 4.97 | NM | 0.03 |
| 0.059 | 0.12 | 5.004 | 0.383 | 0.031 |
| 0.51 | 1.02 | 3.54 | 3.04 | 0.02 |
| 0.46 | 0.954 | 3.551 | 3.011 | 0.032 |

[symbol]

indicates data missing or illegible when filed

### EXAMPLE 5

Nickel-base alloy ingots having the chemistries listed in Table 18 were prepared by vacuum induction melting and vacuum arc remelting. Each heat weighed approximately 300 lb. The values in Table 18 are weight percentages based on total alloy weight. Each alloy also included incidental impurities.

| [symbol] | C | Co | Cr | Fe | Mo | Nb | Ni | Si | Ta | Ti | W | Zr |
|---|---|---|---|---|---|---|---|---|---|---|---|---|
| | 0.05 | 18.105 | 15.96 | 2.016 | 6.265 | <0.01 | 50.1737 | 0.027 | 0.011 | 3.493 | 2.163 | 0.028 |
| | 0.049 | 18.034 | 16.012 | 2.027 | 6.007 | <0.01 | 60.5747 | 0.026 | 0.01 | 3.492 | 2.018 | 0.044 |
| | 0.048 | 18.005 | 15.997 | 2.028 | 5.998 | <0.01 | 50.6387 | 0.02 | 0.011 | 3.48 | 2.019 | 0.034 |
| | 0.049 | 15.997 | 14.979 | 2.001 | 3.105 | 0.497 | 53.7043 | 0.018 | 1.205 | 3.749 | 2.958 | 0.03 |
| | 0.046 | 25.848 | 15.022 | 2.014 | 3.474 | 0.023 | 45.2581 | 0.011 | 0.056 | 4.007 | 2.513 | 0.03 |
| | 0.042 | 18.499 | 13.949 | 2.033 | 2.51 | 0.724 | 52.2888 | 0.016 | 1.475 | 3.023 | 3.474 | 0.029 |
| | 0.046 | 17.967 | 12.045 | 2.04 | 2.975 | 0.76 | 52.2732 | 0.023 | 1.473 | 2.492 | 5.943 | 0.031 |
| | 0.043 | 18.13 | 13.98 | 2.014 | 2.069 | 0.749 | 52.164 | 0.017 | 1.497 | 3.482 | 4.11 | 0.03 |

[symbol]

indicates data missing or illegible when filed

Samples of the heat treated alloys were tested at room temperature and elevated temperature for yield strength, ultimate yield strength, and percent elongation. Additionally, the samples were tested for stress rupture time and elongation to failure at a sample temperature of 1500° F. (816° C.) and with applied stress of 50 ksi (345 MPa). Stress rupture tests were conducted in accordance with ASTM E139-11. Room temperature tensile tests were conducted in accordance with ASTM E8/E8M-22. Elevated temperature tensile tests were conducted in accordance with ASTM E21-20. The test results are shown in Table 19.

TABLE 19
Mechanical Testing Results

| | | | | | | | | Stress Rupture @ | |
|---|---|---|---|---|---|---|---|---|---|
| | | Room Temperature | | | 1500° F. | | | 1500° F. | |
| | | | UTS | | | UTS | | Specimen | |
| Heat | Batch | YS (ksi) | (ksi) | % EL | YS (ksi) | (ksi) | % EL | Life (h) | % EL |
| P2F02 | 476 | 141.3 | 205.6 | 24.6 | 105.8 | 105.8 | 4.4 | N/A | N/A |
| P2F07 | 486 | 126.7 | 196.7 | 29.5 | 105.7 | 111.7 | 19.7 | 89.2 | 29.3 |

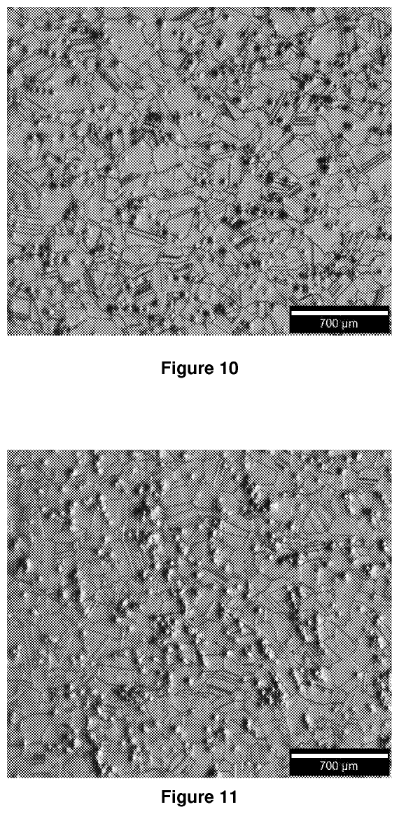

Additionally, samples of heats P2F02 and P2F07 were analyzed for microstructure characteristics as shown in FIG. 10-11. The grain size of P2F02 in FIG. 10 is 8.1 ASTM grain size. The grain size of P2F07 in FIG. 11 is 8.2 ASTM grain size.

### EXAMPLE 6

Nickel-base alloy heats having the chemistries listed in Table 20 were prepared by vacuum induction melting feed materials and subsequent gas atomization to produce metal powders. After gas atomization, the powder heats were screened for use in LPBF printing. The values in Table 20 are weight percentages based on total alloy weight. “NM” signifies that a content was not measured. Each alloy heat also included incidental impurities and balance nickel.

The metallurgical powders were used to additively manufacture test bars for mechanical testing. An SLM 125HL LPBF machine (SLM Solutions, Lübeck, Germany) and an EOS M290 LPBF machine (EOS GmbH, Krailling, Germany) were used to print the test bars using various orientations of the test bars. The SLM machine has a build volume of 125 mm×125 mm×125 mm, and the EOS machine has a build volume of 250 mm×250 mm×325 mm. Both machines use a similar laser and inert gas (argon) system. After printing, the test bars were subjected to tensile testing at different temperatures and stress rupture testing at different temperatures and stresses. The processing of the test bars and mechanical testing results are shown in Tables 21 and 22.

TABLE 20
Powder Heat Chemistries

| [symbol] | Fe | Mo | Nb | Ta | Ti | W | Zr | O | N | Si | Mn | Cu | P | S |
|---|---|---|---|---|---|---|---|---|---|---|---|---|---|---|
| | 2 | 3.58 | — | | 4.97 | — | 0.03 | 0.0048 | 0.0068 | NM | NM | NM | NM | NM |
| | 2 | 2.99 | 0.51 | 1.02 | 3.54 | 3.04 | 0.027 | 0.015 | 0.001 | NM | NM | NM | NM | NM |
| | 2.058 | 3.666 | 0.059 | 0.12 | 5.004 | 0.383 | 0.031 | 0.0137 | 0.0012 | <0.01 | <0.01 | <0.01 | <0.003 | 0.0004 |
| | 1.995 | 3.034 | 0.46 | 0.954 | 3.551 | 3.011 | 0.032 | 0.0139 | 0.0013 | <0.01 | <0.01 | <0.01 | <0.003 | 0.0004 |

[symbol]

indicates data missing or illegible when filed

| | | | | 2050° | 2025° | 2025° | 1550° |
|---|---|---|---|---|---|---|---|
| | | | | F./2 hrs/ | F./2 hrs/ | F./2 hrs/ | F./4 hrs/ |
| Sample | Powder | L-PBF | | Oil | Oil | Slow | Air |
| ID | heat | Machine | HIP | Quench | Quench | Cool | Cooled |
| AM-1 | 523-107 | SLM | X | X | — | — | X |
| AM-2 | 523-107 | SLM | X | X | — | — | X |
| AM-3 | AMABA1C025 | EOS | X | X | — | — | X |
| AM-4 | AMABA1C025 | EOS | X | X | — | — | X |
| AM-5 | AMABA1C025 | EOS | X | X | — | — | X |
| AM-6 | AMABA1C025 | EOS | X | X | — | — | X |
| AM-7 | AMABA1C025 | EOS | X | X | — | — | X |
| AM-8 | AMABA1C025 | EOS | X | X | — | — | X |
| AM-9 | AMABA1C025 | EOS | X | X | — | — | X |
| AM-10 | AMABA1C025 | EOS | X | X | — | — | X |
| AM-11 | AMABA1C025 | EOS | X | X | — | — | X |
| AM-12 | AMABA1C025 | EOS | X | X | — | — | X |
| AM-13 | AMABA1C025 | EOS | X | X | — | — | X |
| AM-14 | AMABA1C025 | EOS | X | X | — | — | X |
| AM-15 | AMABA1C025 | EOS | X | X | — | — | X |
| AM-16 | AMABA1C025 | EOS | X | X | — | — | X |
| AM-17 | AMABA1C025 | EOS | X | X | — | — | X |
| AM-18 | AMABA1C025 | EOS | X | X | — | — | X |
| AM-19 | AMABA1C025 | EOS | X | X | — | — | X |
| AM-20 | AMABA1C025 | EOS | X | X | — | — | X |
| AM-21 | AMABA1C025 | EOS | X | X | — | — | X |
| AM-22 | AMABA1C025 | EOS | X | X | — | — | X |
| [symbol] | AMABA1C025 | EOS | X | X | — | — | X |
| | AMABA1C025 | EOS | X | X | — | — | X |
| | 523-108 | SLM | X | — | — | X | X |
| | 523-108 | SLM | X | — | — | X | X |
| | 523-108 | SLM | X | — | X | — | X |
| | 523-108 | SLM | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | AMABB1C024 | EOS | X | — | X | — | X |
| | 1450° | | | Ultimate | | | % |
| | F./8 hrs/ | | Test | Tensile | Yield | | Reduc. |
| Sample | Air | Print | Temp. | Strength | Strength | % | in |
| ID | Cooled | Orient. | (° F.) | (ksi) | (ksi) | Elong | Area |
| AM-1 | X | Z | 75 | 202.1 | 168.7 | 11 | 18 |
| AM-2 | X | Z | 1500 | 118.6 | 102.5 | 15.5 | 19.5 |
| AM-3 | X | Z | 1650 | 72 | 73 | 14 | 15.5 |
| AM-4 | X | Z | 1800 | 36.5 | 35 | 36.5 | 29 |
| AM-5 | X | X | 75 | 236.9 | 186.7 | 20 | 17 |
| AM-6 | X | X | 75 | 237.1 | 187.6 | 15 | 17 |
| AM-7 | X | Z | 75 | 215.6 | 181.5 | 17 | 27 |
| AM-8 | X | Z | 75 | 216.2 | 181.8 | 13 | 27 |
| AM-9 | X | X | 1472 | 136.9 | 117.6 | 4 | 0.5 |
| AM-10 | X | Z | 1472 | 123.2 | 123 | 2 | 0 |
| AM-11 | X | Z | 1472 | 148 | 125 | 7 | 10.5 |
| AM-12 | X | Z | 1472 | 139.8 | 121.2 | 10 | 14 |
| AM-13 | X | Z | 1472 | 140 | 118.2 | 10 | 10 |
| AM-14 | X | Z | 1650 | 80.1 | 69.5 | 10 | 16 |
| AM-15 | X | X | 1832 | 39.6 | 27 | 20 | 26.5 |
| AM-16 | X | X | 1832 | 35.5 | 21.7 | 20 | 28.5 |
| AM-17 | X | Z | 1832 | 34 | 24.6 | 25 | 33 |
| AM-18 | X | Z | 75 | 217 | 180 | 17 | 23 |
| AM-19 | X | Z | 75 | 205 | 175 | 19 | 28 |
| AM-20 | X | Z | 572 | 207 | 165.5 | 14 | 24.5 |
| AM-21 | X | Z | 572 | 209.5 | 168.5 | 15.5 | 25.5 |
| AM-22 | X | Z | 1112 | 202.5 | 157.5 | 8 | 14 |
| [symbol] | X | Z | [symbol] | 131.5 | 130 | 3.5 | 1.5 |
| | X | Z | 1472 | 124 | 122.5 | 3.5 | 2.5 |
| | X | Z | 75 | 202.2 | 174.3 | 10 | 10 |
| | X | Z | 1500 | 124.5 | 100.3 | 9 | 7.5 |
| | X | Z | 75 | 198.3 | 166.5 | 14 | 15 |
| | X | Z | 1500 | 135.6 | 123.5 | 6 | 6 |
| | X | X | 75 | 226.9 | 160.7 | 15 | 19 |
| | X | X | 75 | 225.4 | 178.9 | 16 | 20 |
| | X | Z | 75 | 206 | 176.3 | 19 | 30 |
| | X | Z | 75 | 206.3 | 176 | 18 | 24 |
| | X | X | 1472 | 138.5 | 137 | 2 | 3 |
| | X | Z | 1472 | 136.7 | 135.9 | 8 | 12.5 |
| | X | Z | 1472 | 137.2 | 136.8 | 9 | 11.5 |
| | X | Z | 1472 | 152 | 145.7 | 7 | 12.5 |
| | X | Z | 1472 | 150.3 | 144.7 | 7 | 9 |
| | X | Z | 1650 | 97.9 | 96.9 | 8 | 9 |
| | X | X | 1832 | 27.5 | 26.4 | 22 | 18.5 |
| | X | X | 1832 | 25.8 | 24.3 | 17 | 23.5 |
| | X | Z | 1832 | 37.9 | 37.6 | 16 | 18 |
| | X | Z | 75 | 216 | 179 | 18 | 24 |
| | X | Z | 75 | 206 | 175 | 21 | 31 |
| | X | Z | 572 | 195.5 | 163 | 17 | 33 |
| | X | Z | 572 | 194.5 | 163 | 16.5 | 33.5 |
| | X | Z | 1112 | 182 | 152.5 | 14.5 | 47 |
| | X | Z | 1112 | 184 | 152.5 | 14.5 | 44 |
| | X | Z | 1472 | 132 | 131.5 | 6.5 | 6.5 |
| | X | Z | 1472 | 131.5 | 129.5 | 8 | 9.5 |

[symbol]

indicates data missing or illegible when filed

TABLE 22
Stress Rupture Testing of Additively Manufactured Parts

| | | | Stress | Larson | Hours | Stress | Test | Test |
|---|---|---|---|---|---|---|---|---|
| | Print | | Applied | Miller | Until | Applied | Temperature | Temperature |
| [symbol] | Oriention | Powder heat | (Mpa) | Parameter | Rupture | (ksi) | (° C.) | (° F.) |
| | Z | AMABA1C025 | 345 | 24.23 | 179.78 | 50 | 815.6 | 1500 |
| | Z | AMABA1C025 | 276 | 24.78 | 571.3 | 40 | 815.6 | 1500 |
| | X | AMABA1C025 | 345 | 23.71 | 124.3 | 50 | 800.0 | 1472 |
| | X | AMABA1C025 | 345 | 23.74 | 132.9 | 50 | 800.0 | 1472 |
| | Z | AMABA1C025 | 345 | 23.89 | 183.6 | 50 | 800.0 | 1472 |
| | Z | AMABA1C025 | 345 | 23.92 | 195.3 | 50 | 800.0 | 1472 |
| | Z | AMABA1C025 | 207 | 24.58 | 803.5 | 30 | 800.0 | 1472 |
| | Z | AMABA1C025 | 207 | 24.81 | 1327 | 30 | 800.0 | 1472 |
| | X | AMABB1C024 | 345 | 23.79 | 147.5 | 50 | 800.0 | 1472 |
| | X | AMABB1C024 | 345 | 23.83 | 159.9 | 50 | 800.0 | 3472 |
| | Z | AMABB1C024 | 345 | 24.00 | 222.9 | 50 | 800.0 | 1472 |
| | Z | AMABB1C024 | 207 | 25.25 | 3394 | 30 | 800.0 | 1472 |
| | Z | AMABB1C024 | 207 | 25.25 | 3373 | 30 | 800.0 | 1472 |

[symbol]

indicates data missing or illegible when filed

The following numbered clauses are directed to various non-limiting embodiments according to the present disclosure:

Clause 1. A nickel-base alloy comprising, in weight percentages based on total alloy weight:
11 to 18 chromium;
16 to 28 cobalt;
1.5 to 7.0 molybdenum;
0 to 6.5 tungsten;
0 to 1.0 niobium;
1.0 to 2.5 aluminum;
2.0 to 6.0 titanium;
0 to 2.0 tantalum;
0 to 4.0 iron;
0 to 0.5 hafnium;
0.01 to 0.2 carbon;
0.001 to 0.02 boron;
0.001 to 0.1 zirconium;
nickel; and
impurities.

Clause 2. The nickel-base alloy of Clause 1, wherein an aluminum equivalent number (Al_{eq}) of the nickel-base alloy is in a range of 3.6 to 4.5.

Clause 3. The nickel-base alloy of any of Clauses 1 and 2, wherein a combined concentration of aluminum and titanium is no greater than 7.0 weight percent, based on total alloy weight.

Clause 4. The nickel-base alloy of any of Clauses 1 and 2, wherein a combined concentration of aluminum and titanium is 5.0 to 7.0 weight percent, based on total alloy weight.

Clause 5. The nickel-base alloy of any of Clauses 1-4, comprising 11 to 16 weight percent chromium, based on total alloy weight.

Clause 6. The nickel-base alloy of any of Clauses 1-5, comprising 0.001 to 0.015 weight percent boron, based on total alloy weight.

Clause 7. The nickel-base alloy of any of Clauses 1-6, comprising at least 36 weight percent nickel, based on total alloy weight.

Clause 8. The nickel-base alloy of any of Clauses 1-7, comprising 16 to 19 weight percent cobalt, based on total alloy weight.

Clause 9. The nickel-base alloy of any of Clauses 1-8, comprising 2.0 to 4.5 weight percent titanium, based on total alloy weight.

Clause 10. The nickel-base alloy of any of Clauses 1-7 comprising, in weight percentages based on total alloy weight:
11 to 16 chromium;
16 to 28 cobalt;
1.5 to 7.0 molybdenum;
0 to 6.5 tungsten;
0 to 1.0 niobium;
1.0 to 2.5 aluminum;
2.0 to 6.0 titanium;
0 to 2.0 tantalum;
0 to 4.0 iron;
0 to 0.5 hafnium;
0.01 to 0.2 carbon;
0.001 to 0.015 boron;
0.001 to 0.1 zirconium;
at least 36 nickel; and
impurities;
wherein the combined concentration of aluminum, niobium, and titanium is no greater than 7.0 weight percent; and
wherein an aluminum equivalent number (Al_{eq}) of the nickel-base alloy is in a range of 3.6 to 4.5.

Clause 11. The nickel-base alloy of any of Clause 10, wherein the combined concentration of aluminum, niobium, and titanium is 5.0 to 7.0 weight percent, based on total alloy weight.

Clause 12. A nickel-base alloy comprising, in weight percentages based on total alloy weight:
11 to 18 chromium;
24 to 28 cobalt;
1.5 to 7.0 molybdenum;
2.0 to 6.0 tungsten;
0 to 1.0 niobium;
1.0 to 2.5 aluminum;
2.0 to 6.0 titanium;
0 to 2.0 tantalum;
0 to 4.0 iron;
0 to 0.5 hafnium;
0.01 to 0.2 carbon;
0.001 to 0.02 boron;
0.001 to 0.1 zirconium;
nickel; and
impurities.

Clause 13. The nickel-base alloy of Clause 12, wherein an aluminum equivalent number (Al_{eq}) of the nickel-base alloy is in a range of 3.6 to 4.5.

Clause 14. The nickel-base alloy of any of Clauses 12-13, wherein a combined concentration of aluminum and titanium is no greater than 7.0 weight percent, based on total alloy weight.

Clause 15. The nickel-base alloy of any of Clauses 12-14, wherein a combined concentration of aluminum and titanium is 5.0 to 7.0 weight percent, based on total alloy weight.

Clause 16. The nickel-base alloy of any of Clauses 12-15, comprising 14 to 16 weight percent chromium, based on total alloy weight.

Clause 17. The nickel-base alloy of any of Clauses 12-16, comprising 24 to 27 weight percent cobalt, based on total alloy weight.

Clause 18. The nickel-base alloy of any of Clauses 12-17, comprising 3.0 to 4.5 weight percent titanium, based on total alloy weight.

Clause 19. The nickel-base alloy of any of Clauses 12-18, comprising 1.7 to 2.0 weight percent aluminum, based on total alloy weight.

Clause 20. The nickel-base alloy of any of Clauses 12-19, comprising 0.001 to 0.015 weight percent boron, based on total alloy weight.

Clause 21. The nickel-base alloy of any of Clauses 12-20, comprising at least 46 weight percent nickel, based on total alloy weight.

Clause 22. The nickel-base alloy of Clause 12 comprising, in weight percentages based on total alloy weight:
14 to 16 chromium;
24 to 27 cobalt;
1.5 to 7.0 molybdenum;
0 to 6.5 tungsten;
0 to 1.0 niobium;
1.7 to 2.0 aluminum;
3.0 to 4.5 titanium;
0 to 2.0 tantalum;
0 to 4.0 iron;
0 to 0.5 hafnium;
0.01 to 0.2 carbon;
0.001 to 0.015 boron;
0.001 to 0.1 zirconium;
at least 46 nickel; and
impurities;
wherein the combined concentration of aluminum, niobium, and titanium is no greater than 7.0 weight percent; and
wherein an aluminum equivalent number (Al_{eq}) of the nickel-base alloy is in a range of 3.6 to 4.5.

Clause 23. The nickel-base alloy of Clause 22, wherein the combined concentration of aluminum, niobium, and titanium is 5.0 to 7.0 weight percent, based on total alloy weight.

Clause 24. A nickel-base alloy comprising, in weight percentages based on total alloy weight:
11 to 18 chromium;
16 to 28 cobalt;
1.5 to 7.0 molybdenum;
0 to 6.5 tungsten;
0 to 1.0 niobium;
1.0 to 2.5 aluminum;
2.0 to 6.0 titanium;
0 to 2.0 tantalum;
0 to 4.0 iron;
0 to 0.5 hafnium;
0.01 to 0.2 carbon;
0.001 to 0.02 boron;
0.001 to 0.1 zirconium;
nickel; and
impurities.

Clause 25. The nickel-base alloy of Clause 24, wherein an aluminum equivalent number (Al_{eq}) of the nickel-base alloy is in a range of 3.6 to 4.5.

Clause 26. The nickel-base alloy of any of Clauses 24-25, wherein a combined concentration of aluminum and titanium is no greater than 7.0 weight percent, based on total alloy weight.

Clause 27. The nickel-base alloy of any of Clauses 24-26, wherein a combined concentration of aluminum and titanium is 5.0 to 7.0 weight percent, based on total alloy weight.

Clause 28. The nickel-base alloy of any of clauses 24-27, comprising 13 to 17 weight percent chromium, based on total alloy weight.

Clause 29. The nickel-base alloy of any of Clauses 24-28, comprising 0.001 to 0.015 weight percent boron, based on total alloy weight.

Clause 30. The nickel-base alloy of any of Clauses 24-29, comprising at least 36 weight percent nickel, based on total alloy weight.

Clause 31. The nickel-base alloy of any of Clauses 24-30, comprising 16 to 25 weight percent cobalt, based on total alloy weight.

Clause 32. The nickel-base alloy of any of Clauses 24-31, comprising 3.0 to 6.0 weight percent titanium, based on total alloy weight.

Clause 33. The nickel-base alloy of any of Clauses 24-32, comprising 13 to 17 weight percent chromium, based on total alloy weight.

Clause 34. The nickel-base alloy of any of Clauses 24-33, comprising 1 to 6.5 weight percent tungsten, based on total alloy weight.

Clause 35. The nickel-base alloy of any of Clauses 24-34, comprising 0 to 0.05 weight percent magnesium, based on total alloy weight.

Clause 36. The nickel-base alloy of Clause 24 comprising, in weight percentages based on total alloy weight:
13 to 17 chromium;
16 to 25 cobalt;
1.5 to 7.0 molybdenum;
0 to 6.5 tungsten;
0 to 1.0 niobium;
1.0 to 2.5 aluminum;
3.0 to 6.0 titanium;
0 to 2.0 tantalum;
0 to 4.0 iron;
0 to 0.5 hafnium;
0.01 to 0.2 carbon;
0.001 to 0.015 boron;
0.001 to 0.1 zirconium;
optionally trace elements;
at least 36 nickel; and
impurities.

Clause 37. The nickel-base alloy of Clause 36, wherein the combined concentration of aluminum, niobium, and titanium is no greater than 7.0 weight percent.

Clause 38. The nickel-base alloy of any of Clauses 36-37, wherein an aluminum equivalent number (Al_{eq}) of the nickel-base alloy is in a range of 3.6 to 4.5.

Clause 39. The nickel-base alloy of any of Clauses 36-38, wherein the combined concentration of aluminum, niobium, and titanium is 5.0 to 7.0 weight percent, based on total alloy weight.

Clause 40. The nickel-base alloy of any of Clauses 36-39, comprising 16 to 19 weight percent cobalt, based on total alloy weight.

Clause 41. The nickel-base alloy of any of Clauses 36-39, comprising 19 to 25 weight percent cobalt, based on total alloy weight.

Clause 42. The nickel-base alloy of any of Clauses 36-41, comprising 2.0 to 4.0 weight percent molybdenum, based on total alloy weight.

Clause 43. The nickel-base alloy of any of Clauses 36-41, comprising 4.0 to 6.0 weight percent molybdenum, based on total alloy weight.

Clause 44. The nickel-base alloy of any of Clauses 36-43, comprising 0 to 0.5 weight percent tungsten, based on total alloy weight.

Clause 45. The nickel-base alloy of any of Clauses 36-43, comprising 2.0 to 5.0 weight percent tungsten, based on total alloy weight.

Clause 46. The nickel-base alloy of any of Clauses 36-45, comprising 1.25 to 1.9 weight percent aluminum, based on total alloy weight.

Clause 47. The nickel-base alloy of any of Clauses 36-46, comprising 1.0 to 3.0 weight percent iron, based on total alloy weight.

Clause 48. The nickel-base alloy of any of Clauses 36-47, comprising 0.6 to 2.0 weight percent tantalum, based on total alloy weight.

Clause 49. The nickel-base alloy of any of Clauses 36-47, comprising 0 to 0.5 weight percent tantalum, based on total alloy weight.

Clause 50. The nickel-base alloy of any of Clauses 36-49, comprising 3.0 to 4.0 weight percent titanium, based on total alloy weight.

Clause 51. The nickel-base alloy of any of Clauses 36-49, comprising 4.5 to 5.5 weight percent titanium, based on total alloy weight.

Clause 52. The nickel-base alloy of any of Clauses 36-51, comprising 14 to 17 weight percent chromium, based on total alloy weight.

Clause 53. The nickel-base alloy of any of Clauses 36-52, comprising 0.2 to 1.0 weight percent niobium, based on total alloy weight.

Clause 54. The nickel-base alloy of any of Clauses 36-53, comprising at least 46 weight percent nickel, based on total alloy weight.

Clause 55. The nickel-base alloy of any of Clauses 36-54, wherein an aluminum equivalent number (Al_{eq}) of the nickel-base alloy is in a range of 3.6 to 4.2.

Clause 56. The nickel-base alloy of any of Clauses 36-55, wherein an aluminum equivalent number (Al_{eq}) of the nickel-base alloy is in a range of 4.0 to 4.5.

Clause 57. The nickel-base alloy of any of Clauses 36-56, wherein the combined concentration of aluminum, niobium, and titanium is 5.0 to 6.0 weight percent, based on total alloy weight.

Clause 58. The nickel-base alloy of any of Clauses 36-57, wherein the combined concentration of aluminum, niobium, and titanium is 6.0 to 7.0 weight percent, based on total alloy weight.

Clause 59. The nickel-base alloy of any of Clauses 36-58, wherein the trace elements comprise 0 to 0.05 weight percent magnesium, based on total alloy weight.

Clause 60. A nickel-base alloy comprising, in weight percentages based on total alloy weight:
13 to 17 chromium;
16 to 19 cobalt;
1.5 to 7.0 molybdenum;
2.0 to 5.0 tungsten;
0 to 1.0 niobium;
1.0 to 2.5 aluminum;
3.0 to 6.0 titanium;
0 to 2.0 tantalum;
0 to 3.0 iron;
0 to 0.5 hafnium;
0.01 to 0.2 carbon;
0.001 to 0.015 boron;
0.001 to 0.1 zirconium;
optionally trace elements;
at least 46 nickel; and
impurities;
wherein an aluminum equivalent number (Al_{eq}) of the nickel-base alloy is in a range of 3.6 to 4.5 and wherein the combined concentration of aluminum, niobium, and titanium is 5.0 to 7.0 weight percent, based on total alloy weight.

Clause 61. A nickel-base alloy comprising, in weight percentages based on total alloy weight:
14 to 17 chromium;
19 to 25 cobalt;
2.0 to 4.0 molybdenum;
0 to 6.5 tungsten;
0 to 0.8 niobium;
1.0 to 2.5 aluminum;
3.0 to 6.0 titanium;
0 to 2.0 tantalum;
0 to 3.0 iron;
0 to 0.5 hafnium;
0.01 to 0.2 carbon;
0.001 to 0.015 boron;
0.001 to 0.1 zirconium;
optionally trace elements;
at least 46 nickel; and
impurities;
wherein an aluminum equivalent number (Al_{eq}) of the nickel-base alloy is in a range of 3.6 to 4.5 and wherein the combined concentration of aluminum, niobium, and titanium is 5.0 to 7.0 weight percent, based on total alloy weight.

Clause 62. A nickel-base alloy comprising, in weight percentages based on total alloy weight:
14 to 17 chromium;
16 to 19 cobalt;
2.0 to 4.0 molybdenum;
2.0 to 5.0 tungsten;
0 to 1.0 niobium;
1.0 to 2.5 aluminum;
3.0 to 6.0 titanium;
greater than 0 to 2.0 tantalum;
1.0 to 3.0 iron;
0 to 0.5 hafnium;
0.01 to 0.2 carbon;
0.001 to 0.015 boron;
0.001 to 0.1 zirconium;
optionally trace elements;
at least 46 nickel; and
impurities;
wherein an aluminum equivalent number (Al_{eq}) of the nickel-base alloy is in a range of 3.6 to 4.5 and wherein the combined concentration of aluminum, niobium, and titanium is 5.0 to 7.0 weight percent, based on total alloy weight.

Clause 63. An additively manufactured part comprising the nickel-base alloy of any of clauses 24-62.

Clause 64. The additively manufactured part of clause 63, wherein the additively manufactured part comprises at least one part selected from the group consisting of heat exchangers, nose cones, scramjet engine components, vehicle leading edges, heat pipes, a reentry structure, actively or passively cooled controlled surfaces, a skin of a vehicle, a component of a ramjet, a component of a rocket motor, a component of a combined cycle motor, a component of a rotary detonation motor, a component of gasification equipment, a component of chemical processing equipment, and a component of a fastening system.

Clause 65. The nickel-base alloy of any of clauses 24-62, wherein the nickel-base alloy exhibits:
a yield strength in an aged condition at room temperature of at least 120 ksi (827 MPa);
a yield strength in an aged condition at 1500° F. (816° C.) of at least 90 ksi (621 MPa);
an ultimate tensile strength in an aged condition at room temperature of at least 180 ksi (1241 MPa);
an ultimate tensile strength in an aged condition at 1500° F. (816° C.) of at least 90 ksi (621 MPa); and
a percent elongation in an aged condition at room temperature in a range of 15% to 40%.

Clause 66. The nickel-base alloy of any of clauses 24-62, wherein the nickel-base alloy exhibits:
a yield strength in an aged condition at room temperature of at least 125 ksi (862 MPa);
a yield strength in an aged condition at 1500° F. (816° C.) of at least 100 ksi (689 MPa);
an ultimate tensile strength in an aged condition at room temperature of at least 195 ksi (1344 MPa);
an ultimate tensile strength in an aged condition at 1500° F. (816° C.) of at least 105 ksi (724 MPa); and
a percent elongation in an aged condition at room temperature in a range of 25% to 35%.

Clause 67. A nickel-base alloy comprising, in weight percentages based on total alloy weight:
15 to 17 chromium;
22 to 26 cobalt;
2.0 to 4.0 molybdenum;
0 to 2.0 tungsten;
0 to 1.0 niobium;
1.0 to 4.0 aluminum;
1.0 to 6.0 titanium;
0 to 2.0 tantalum;
0 to 4.0 iron;
0 to 0.5 hafnium;
0 to 0.2 carbon;
0 to 0.02 boron;
0 to 0.1 zirconium;
nickel; and
impurities.

Clause 68. A nickel-base alloy comprising, in weight percentages based on total alloy weight:
14 to 17 chromium;
15 to 18 cobalt;
2.0 to 4.0 molybdenum;
1.0 to 4.0 tungsten;
0 to 1.0 niobium;
1.0 to 3.0 aluminum;
2.0 to 4.0 titanium;
0 to 2.0 tantalum;
0 to 4.0 iron;
0 to 0.5 hafnium;
0 to 0.2 carbon;
0 to 0.02 boron;
0 to 0.1 zirconium;
nickel; and
impurities.

It will be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A gamma-prime strengthened nickel-based alloy comprising, in weight percentages based on total weight of the nickel-base alloy:
15% to 18% chromium;
16% to 19% cobalt;
2% to 4% molybdenum;
1.5% to 5% tungsten;
0 to 2% niobium;
1% to 3% aluminum;
2% to 5% titanium;
0 to 2% tantalum;
0 to 4% iron;
0 to 0.5% hafnium;
0 to 0.2% carbon;
0 to 0.02% boron;
0 to 0.1% zirconium; and
nickel,
wherein the nickel-based alloy has a Ti_{eq}/Al_{eq} ratio of 0.9 to 1.25, and Ti_{eq} of 2.0 to 7.15, and
wherein the nickel-based alloy has 25-40% gamma-prime as measured at 1500° F.

2. The nickel-base alloy of claim 1, wherein the alloy comprises at least 46 weight percent nickel, based on total alloy weight.

3. The nickel-base alloy of claim 1, wherein the alloy comprises 1.5% to 4% molybdenum, based on total alloy weight.

4. The nickel-base alloy of claim 1, wherein the alloy comprises greater than 0 to 1% niobium, based on total alloy weight.

5. The nickel-base alloy of claim 1, wherein the alloy comprises 1% to 2% aluminum, based on total alloy weight.

6. The nickel-base alloy of claim 1, wherein the alloy comprises 2% to 4.5% titanium, based on total alloy weight.

7. The nickel-base alloy of claim 1, wherein the alloy comprises greater than 0 to 2% tantalum, based on total alloy weight.

8. The nickel-base alloy of claim 1, wherein the alloy comprises greater than 0.001% to 0.01% boron, based on total alloy weight.

9. The nickel-base alloy of claim 1, wherein the alloy comprises greater than 0.001% to 0.05% zirconium, based on total alloy weight.

10. The nickel-base alloy of claim 1, wherein an aluminum equivalent number (Al_{eq}) of the nickel-base alloy is in a range of 3.6 to 4.5.

11. The nickel-base alloy of claim 10, wherein the aluminum equivalent number (Al_{eq}) is in a range of 3.75 to 4.25.

12. The nickel-base alloy of claim 1, wherein the concentrations of molybdenum and tungsten satisfy: 3%<[Mo]+0.52×[W]<8%, wherein [Mo] and [W] are the weight percentage concentrations of molybdenum and tungsten in the alloy, respectively.

13. The nickel-base alloy of claim 12, wherein the concentrations of molybdenum and tungsten satisfy: 3%<[Mo]+0.52×[W]<5%.

14. The nickel-base alloy of claim 1, wherein a combined concentration of aluminum and titanium is in a range of 5.0 to 7.0 wt. %, based on total alloy weight.

15. The nickel-base alloy of claim 14, wherein the combined concentration of aluminum and titanium is in a range of 5.0 to 6.0 wt. %, based on total alloy weight.

16. The nickel-base alloy of claim 1, wherein a combined concentration of aluminum, niobium, and titanium is in a range of 5.0 to 7.0 wt. %, based on total alloy weight.

17. The nickel-base alloy of claim 16, wherein the combined concentration of aluminum, niobium, and titanium is in a range of 5.0 to 6.0 wt. %, based on total alloy weight.

18. The nickel-base alloy of claim 1, wherein a titanium/aluminum weight percentage ratio is in a range of 1.2 to 4.0.

19. The nickel-base alloy of claim 18, wherein the titanium/aluminum weight percentage ratio is in a range of 1.5 to 2.4.

20. The nickel-base alloy of claim 18, wherein the titanium/aluminum weight percentage ratio is in a range of 1.7 to 2.2.

21. The nickel-base alloy of claim 1, wherein a gamma-prime solvus temperature of the alloy is no greater than 2050° F. (1121° C.).

22. The nickel-base alloy of claim 21, wherein the gamma-prime solvus temperature is below 2000° F. (1066° C.).

23. The nickel-base alloy of claim 1, wherein the nickel-base alloy exhibits, in an aged condition: a yield strength at room temperature of at least 120 ksi (827 MPa); a yield strength at 1500° F. (816° C.) of at least 90 ksi (621 MPa); an ultimate tensile strength at room temperature of at least 180 ksi (1241 MPa); an ultimate tensile strength at 1500° F. (816° C.) of at least 90 ksi (621 MPa); and a percent elongation at room temperature in a range of 15% to 40%.

24. The nickel-base alloy of claim 1, wherein the nickel-base alloy exhibits, in an aged condition, a stress rupture life of at least 100 hours at 1500° F. (816° C.) under an applied stress of 50 ksi (345 MPa).

25. The nickel-base alloy of claim 1, wherein the nickel-base alloy exhibits, in an aged condition, a stress rupture life of at least 250 hours at 1500° F. (816° C.) under an applied stress of 40 ksi (276 MPa).

26. A method of forming a component comprising:
providing a powder comprising the nickel-base alloy of claim 1;
additively manufacturing the component from the powder; and
heat treating the additively manufactured component.

27. The method of claim 26, wherein additively manufacturing the component comprises additively manufacturing the component from the powder using a laser powder bed fusion (LPBF) process under an inert gas atmosphere.

28. The method of claim 26, wherein heat treating the additively manufactured component comprises:
solutionizing the gamma-prime at approximately 50° F. (27.8° C.) below the gamma-prime solvus followed by quenching;
aging at 1550° F. (843° C.) followed by cooling; and
aging at 1450° F. (787° C.).

29. The method of claim 26, wherein the powder is produced by gas atomization of a vacuum induction melted feed material.

30. The method of claim 29, wherein the gas atomization is vacuum-melt inert gas atomization (VIGA), electrode inductive gas atomization (EIGA), close-coupled gas atomization, cold-wall inert gas atomization, or rotary electrode process atomization.

31. The method of claim 27, wherein the laser powder bed fusion process is selective laser melting (SLM).

32. The method of claim 27, wherein the laser powder bed fusion process is direct metal laser sintering (DMLS).

33. The method of claim 26, wherein additively manufacturing the component comprises printing the component, and wherein the component is printed in a Z-orientation or an X-orientation.

34. The method of claim 28, further comprising hot isostatic pressing the additively manufactured component prior to the solutionizing step.

35. The method of claim 26, wherein the heat treating comprises: (i) solutionizing the gamma-prime at 2050° F. (1121° C.) for 30 minutes followed by air cooling; and (ii) aging at 1650° F. (899° C.) for 4 hours followed by air cooling.

36. The method of claim 26, wherein the heat treating comprises: (i) solutionizing the gamma-prime at 2025° F. (1107° C.) for 2 hours followed by oil quenching; (ii) aging at 1550° F. (843° C.) for 4 hours followed by air cooling; and (iii) aging at 1450° F. (787° C.) for 8 hours followed by air cooling.

37. The method of claim 26, wherein the component is selected from the group consisting of a heat exchanger, a nose cone, a scramjet engine component, a vehicle leading edge, a heat pipe, a reentry structure, an actively or passively cooled controlled surface, a vehicle skin, a component of a ramjet, a component of a rocket motor, a component of a combined cycle motor, a component of a rotary detonation motor, a component of gasification equipment, a component of chemical processing equipment, and a component of a fastening system.

38. The method of claim 26, wherein the additively manufacturing step uses an electron beam melting (EBM) process.
